(19) United States
(12) Patent Application Publication
(10) Pub. No.: US 2026/0019821 A1
(43) Pub. Date: Jan. 15, 2026

(54) ENHANCED RELIABILITY OF RADAR DETECTION IN SHARED SPECTRUM SYSTEMS

(71) Applicant: Nokia Solutions and Networks Oy, Espoo (FI)

(72) Inventors: Mohammad KHAWER, Murray Hill, NJ (US); Milind BUDDHIKOT, Murray Hill, NJ (US)

(21) Appl. No.: 18/767,082

(22) Filed: Jul. 9, 2024

(51) Int. Cl. H04W 16/14; G01S 7/02

(52) U.S. Cl. CPC H04W 16/14; G01S 7/021

(57) ABSTRACT

Various example embodiments provide techniques for providing enhanced availability and reliability of Citizens Broadband Radio Service (CBRS) private enterprise cellular service in a dynamic protection area (DPA) of a shared spectrum system, obviating the need for activating protection for the entire lower 100 MHz of the CBRS band when a high-power incumbent is present in the DPA and instead supporting targeted activation of protection for the channel(s) of the lower 100 MHz of the CBRS band used by any incumbents present within the DPA. The targeted activation of protection for the channel(s) of the lower 100 MHz of the CBRS band used by any incumbents present within the DPA may be based on use of an outer corrective loop, based on an external attenuator and a control computer for the environmental sensing capability (ESC) sensor, to take the ESC sensor out of the receiver saturation event and identify channel(s) being used by incumbents so that targeted DPA activation may be achieved.

### TECHNICAL FIELD

Various example embodiments relate generally to communication systems and, more particularly but not exclusively, to supporting shared spectrum systems.

### BACKGROUND

Spectrum is the most precious commodity in deploying wireless networks such as a private enterprise network. Cellular communication systems, such as networks that provide wireless connectivity using Long Term Evolution (LTE) or Fifth Generation (5G) standards, provide more reliable service and superior quality-of-service (QOS) than comparable services provided by conventional contention-based services in unlicensed frequency bands, such as Wi-Fi. The most valuable spectrum available for cellular communication is at frequencies below 6 Gigahertz (GHz) because transmissions at these frequencies do not require a clear line of sight between the transmitter and the receiver. Much of the sub-6-GHz spectrum is already auctioned off as statically licensed spectrum to various mobile network operators (MNOs) that implement cellular communication system such as LTE networks. The 3.1-4.2 GHz spectrum is occupied by incumbents such as Fixed Satellite System (FSS) and federal incumbents such as U.S. government or military entities. For example, the 3550-3700 MHz frequency band (CBRS band) was previously reserved for exclusive use by incumbents including the United States Navy and Fixed Satellite Service (FSS) earth stations. This band of the spectrum is often highly underutilized. Consequently, organizations and vertical industries such as package distribution companies, energy producers, ports, mines, hospitals, and universities do not have access to sub-6-GHz spectrum and are therefore unable to establish private enterprise networks to provide cellular service such as LTE.

### SUMMARY

In at least some example embodiments, an apparatus includes at least one processor and at least one memory storing instructions which, when executed by the at least one processor, cause the apparatus at least to maintain, based on reporting from a radar detection sensor, a list of incumbents associated with a dynamic protection area (DPA) for a Citizens Broadband Radio Service (CBRS) shared spectrum band, receive, from the radar detection sensor, an indication of a receiver saturation event associated with a new incumbent associated with the DPA for the CBRS shared spectrum band, activate, based on the indication of the receiver saturation event, operation of an attenuator to perform attenuation for the radar detection sensor, modulate the attenuator to identify an attenuation level that eliminates the receiver saturation event and that permits identification of a set of occupied channels of the CBRS shared spectrum band that includes any channels of the CBRS shared spectrum band occupied by the incumbents in the list of incumbents and a set of channels of the CBRS shared spectrum band occupied by the new incumbent, and report, to an environmental sensing capability (ESC) entity, a channel occupation status indicative of the set of occupied channels of the CBRS shared spectrum band. In at least some example embodiments, the list of incumbents includes at least one low-power incumbent and the new incumbent includes a high-power incumbent. In at least some example embodiments, the list of incumbents includes at least one additional high-power incumbent. In at least some example embodiments, the indication of the receiver saturation event associated with the new incumbent associated with the DPA for the CBRS shared spectrum band is received based on a failure of an attenuator of the radar detection sensor to eliminate the receiver saturation event for the radar detection sensor. In at least some example embodiments, the instructions, when executed by the at least one processor, cause the apparatus at least to prevent reporting of the receiver saturation event to the ESC entity for preventing activation of protection by the ESC entity for the entire CBRS shared spectrum band as opposed to only the set of occupied channels of the CBRS shared spectrum band. In at least some example embodiments, the attenuation level of the attenuator at activation is a maximum possible attenuation level of the attenuator. In at least some example embodiments, to modulate the attenuator, the instructions, when executed by the at least one processor, cause the apparatus at least to decrease the attenuation level of the attenuator based on a determination that the radar detection sensor is not taken out of the receiver saturation event by a previous attenuation modulation operation performed for the attenuator. In at least some example embodiments, the attenuation level is decreased by half of a previous value of the attenuation level resulting from the previous attenuation modulation operation performed for the attenuator. In at least some example embodiments, to modulate the attenuator, the instructions, when executed by the at least one processor, cause the apparatus at least to increase the attenuation level of the attenuator based on a determination that the radar detection sensor is taken out of the receiver saturation event by a previous attenuation modulation operation performed for the attenuator. In at least some example embodiments, the attenuation level is increased by half of a previous value of the attenuation level resulting from the previous attenuation modulation operation performed for the attenuator. In at least some example embodiments, to modulate the attenuator, the instructions, when executed by the at least one processor, cause the apparatus at least to decrease the attenuation level of the attenuator based on a determination that the radar detection sensor is taken out of the receiver saturation event by a previous attenuation modulation operation performed for the attenuator and a determination that the set of occupied channels of the CBRS shared spectrum band is successfully identified. In at least some example embodiments, the attenuation level is decreased by half of a previous value of the attenuation level resulting from the previous attenuation modulation operation performed for the attenuator. In at least some example embodiments, the instructions, when executed by the at least one processor, cause the apparatus at least to periodically perform a process for iteratively decreasing the attenuation level of the attenuator until detecting a new receiver saturation event or until the attenuation level of the attenuator reaches zero. In at least some example embodiments, the instructions, when executed by the at least one processor, cause the apparatus at least to modulate, based on a determination that the new receiver saturation event is detected, the attenuator to identify a new attenuation level that eliminates the receiver saturation event and that permits identification of the set of occupied channels of the CBRS shared spectrum band. In at least some example embodiments, the instructions, when executed by the at least one processor, cause the apparatus at least to deactivate the attenuator to determine whether the receiver saturation event is still present and update the list of incumbents associated with the DPA for the CBRS shared spectrum band, while the attenuator is deactivated, to obtain an updated list of incumbents associated with the DPA for the CBRS shared spectrum band. In at least some example embodiments, the instructions, when executed by the at least one processor, cause the apparatus at least to reactivate the attenuator based on detection of a new receiver saturation event while the attenuator is deactivated and modulate, based on the new receiver saturation event and the updated list of incumbents associated with the DPA for the CBRS shared spectrum band, the attenuator to identify a new attenuation level that eliminates the receiver saturation event and that permits identification of the set of occupied channels of the CBRS shared spectrum band. In at least some example embodiments, the attenuation level comprises a minimum attenuation level that eliminates the receiver saturation event and that permits identification of the set of occupied channels of the CBRS shared spectrum band. In at least some example embodiments, the CBRS shared spectrum band comprises a lower 100 MHz of the CBRS band.

In at least some example embodiments, a computer-readable medium stores computer program instructions which, when executed by an apparatus, cause the apparatus at least to maintain, based on reporting from a radar detection sensor, a list of incumbents associated with a dynamic protection area (DPA) for a Citizens Broadband Radio Service (CBRS) shared spectrum band, receive, from the radar detection sensor, an indication of a receiver saturation event associated with a new incumbent associated with the DPA for the CBRS shared spectrum band, activate, based on the indication of the receiver saturation event, operation of an attenuator to perform attenuation for the radar detection sensor, modulate the attenuator to identify an attenuation level that eliminates the receiver saturation event and that permits identification of a set of occupied channels of the CBRS shared spectrum band that includes any channels of the CBRS shared spectrum band occupied by the incumbents in the list of incumbents and a set of channels of the CBRS shared spectrum band occupied by the new incumbent, and report, to an environmental sensing capability (ESC) entity, a channel occupation status indicative of the set of occupied channels of the CBRS shared spectrum band. In at least some example embodiments, the list of incumbents includes at least one low-power incumbent and the new incumbent includes a high-power incumbent. In at least some example embodiments, the list of incumbents includes at least one additional high-power incumbent. In at least some example embodiments, the indication of the receiver saturation event associated with the new incumbent associated with the DPA for the CBRS shared spectrum band is received based on a failure of an attenuator of the radar detection sensor to eliminate the receiver saturation event for the radar detection sensor. In at least some example embodiments, the computer program instructions, when executed by the apparatus, cause the apparatus at least to prevent reporting of the receiver saturation event to the ESC entity for preventing activation of protection by the ESC entity for the entire CBRS shared spectrum band as opposed to only the set of occupied channels of the CBRS shared spectrum band. In at least some example embodiments, the attenuation level of the attenuator at activation is a maximum possible attenuation level of the attenuator. In at least some example embodiments, to modulate the attenuator, the computer program instructions, when executed by the apparatus, cause the apparatus at least to decrease the attenuation level of the attenuator based on a determination that the radar detection sensor is not taken out of the receiver saturation event by a previous attenuation modulation operation performed for the attenuator. In at least some example embodiments, the attenuation level is decreased by half of a previous value of the attenuation level resulting from the previous attenuation modulation operation performed for the attenuator. In at least some example embodiments, to modulate the attenuator, the computer program instructions, when executed by the apparatus, cause the apparatus at least to increase the attenuation level of the attenuator based on a determination that the radar detection sensor is taken out of the receiver saturation event by a previous attenuation modulation operation performed for the attenuator. In at least some example embodiments, the attenuation level is increased by half of a previous value of the attenuation level resulting from the previous attenuation modulation operation performed for the attenuator. In at least some example embodiments, to modulate the attenuator, the computer program instructions, when executed by the apparatus, cause the apparatus at least to decrease the attenuation level of the attenuator based on a determination that the radar detection sensor is taken out of the receiver saturation event by a previous attenuation modulation operation performed for the attenuator and a determination that the set of occupied channels of the CBRS shared spectrum band is successfully identified. In at least some example embodiments, the attenuation level is decreased by half of a previous value of the attenuation level resulting from the previous attenuation modulation operation performed for the attenuator. In at least some example embodiments, the computer program instructions, when executed by the apparatus, cause the apparatus at least to periodically perform a process for iteratively decreasing the attenuation level of the attenuator until detecting a new receiver saturation event or until the attenuation level of the attenuator reaches zero. In at least some example embodiments, the computer program instructions, when executed by the apparatus, cause the apparatus at least to modulate, based on a determination that the new receiver saturation event is detected, the attenuator to identify a new attenuation level that eliminates the receiver saturation event and that permits identification of the set of occupied channels of the CBRS shared spectrum band. In at least some example embodiments, the computer program instructions, when executed by the apparatus, cause the apparatus at least to deactivate the attenuator to determine whether the receiver saturation event is still present and update the list of incumbents associated with the DPA for the CBRS shared spectrum band, while the attenuator is deactivated, to obtain an updated list of incumbents associated with the DPA for the CBRS shared spectrum band. In at least some example embodiments, the computer program instructions, when executed by the apparatus, cause the apparatus at least to reactivate the attenuator based on detection of a new receiver saturation event while the attenuator is deactivated and modulate, based on the new receiver saturation event and the updated list of incumbents associated with the DPA for the CBRS shared spectrum band, the attenuator to identify a new attenuation level that eliminates the receiver saturation event and that permits identification of the set of occupied channels of the CBRS shared spectrum band. In at least some example embodiments, the attenuation level comprises a minimum attenuation level that eliminates the receiver saturation event and that permits identification of the set of occupied channels of the CBRS shared spectrum band. In at least some example embodiments, the CBRS shared spectrum band comprises a lower 100 MHz of the CBRS band.

In at least some example embodiments, a method includes maintaining, based on reporting from a radar detection sensor, a list of incumbents associated with a dynamic protection area (DPA) for a Citizens Broadband Radio Service (CBRS) shared spectrum band, receiving, from the radar detection sensor, an indication of a receiver saturation event associated with a new incumbent associated with the DPA for the CBRS shared spectrum band, activating, based on the indication of the receiver saturation event, operation of an attenuator to perform attenuation for the radar detection sensor, modulating the attenuator to identify an attenuation level that eliminates the receiver saturation event and that permits identification of a set of occupied channels of the CBRS shared spectrum band that includes any channels of the CBRS shared spectrum band occupied by the incumbents in the list of incumbents and a set of channels of the CBRS shared spectrum band occupied by the new incumbent, and reporting, to an environmental sensing capability (ESC) entity, a channel occupation status indicative of the set of occupied channels of the CBRS shared spectrum band. In at least some example embodiments, the list of incumbents includes at least one low-power incumbent and the new incumbent includes a high-power incumbent. In at least some example embodiments, the list of incumbents includes at least one additional high-power incumbent. In at least some example embodiments, the indication of the receiver saturation event associated with the new incumbent associated with the DPA for the CBRS shared spectrum band is received based on a failure of an attenuator of the radar detection sensor to eliminate the receiver saturation event for the radar detection sensor. In at least some example embodiments, the method includes preventing reporting of the receiver saturation event to the ESC entity for preventing activation of protection by the ESC entity for the entire CBRS shared spectrum band as opposed to only the set of occupied channels of the CBRS shared spectrum band. In at least some example embodiments, the attenuation level of the attenuator at activation is a maximum possible attenuation level of the attenuator. In at least some example embodiments, modulating the attenuator includes decreasing the attenuation level of the attenuator based on a determination that the radar detection sensor is not taken out of the receiver saturation event by a previous attenuation modulation operation performed for the attenuator. In at least some example embodiments, the attenuation level is decreased by half of a previous value of the attenuation level resulting from the previous attenuation modulation operation performed for the attenuator. In at least some example embodiments, modulating the attenuator includes increasing the attenuation level of the attenuator based on a determination that the radar detection sensor is taken out of the receiver saturation event by a previous attenuation modulation operation performed for the attenuator. In at least some example embodiments, the attenuation level is increased by half of a previous value of the attenuation level resulting from the previous attenuation modulation operation performed for the attenuator. In at least some example embodiments, modulating the attenuator includes decreasing the attenuation level of the attenuator based on a determination that the radar detection sensor is taken out of the receiver saturation event by a previous attenuation modulation operation performed for the attenuator and a determination that the set of occupied channels of the CBRS shared spectrum band is successfully identified. In at least some example embodiments, the attenuation level is decreased by half of a previous value of the attenuation level resulting from the previous attenuation modulation operation performed for the attenuator. In at least some example embodiments, the method includes periodically performing a process for iteratively decreasing the attenuation level of the attenuator until detecting a new receiver saturation event or until the attenuation level of the attenuator reaches zero. In at least some example embodiments, the method includes modulating, based on a determination that the new receiver saturation event is detected, the attenuator to identify a new attenuation level that eliminates the receiver saturation event and that permits identification of the set of occupied channels of the CBRS shared spectrum band. In at least some example embodiments, the method includes deactivating the attenuator to determine whether the receiver saturation event is still present and updating the list of incumbents associated with the DPA for the CBRS shared spectrum band, while the attenuator is deactivated, to obtain an updated list of incumbents associated with the DPA for the CBRS shared spectrum band. In at least some example embodiments, the method includes reactivating the attenuator based on detection of a new receiver saturation event while the attenuator is deactivated and modulating, based on the new receiver saturation event and the updated list of incumbents associated with the DPA for the CBRS shared spectrum band, the attenuator to identify a new attenuation level that eliminates the receiver saturation event and that permits identification of the set of occupied channels of the CBRS shared spectrum band. In at least some example embodiments, the attenuation level comprises a minimum attenuation level that eliminates the receiver saturation event and that permits identification of the set of occupied channels of the CBRS shared spectrum band. In at least some example embodiments, the CBRS shared spectrum band comprises a lower 100 MHz of the CBRS band.

In at least some example embodiments, an apparatus includes means for maintaining, based on reporting from a radar detection sensor, a list of incumbents associated with a dynamic protection area (DPA) for a Citizens Broadband Radio Service (CBRS) shared spectrum band, means for receiving, from the radar detection sensor, an indication of a receiver saturation event associated with a new incumbent associated with the DPA for the CBRS shared spectrum band, means for activating, based on the indication of the receiver saturation event, operation of an attenuator to perform attenuation for the radar detection sensor, means for modulating the attenuator to identify an attenuation level that eliminates the receiver saturation event and that permits identification of a set of occupied channels of the CBRS shared spectrum band that includes any channels of the CBRS shared spectrum band occupied by the incumbents in the list of incumbents and a set of channels of the CBRS shared spectrum band occupied by the new incumbent, and means for reporting, to an environmental sensing capability (ESC) entity, a channel occupation status indicative of the set of occupied channels of the CBRS shared spectrum band. In at least some example embodiments, the list of incumbents includes at least one low-power incumbent and the new incumbent includes a high-power incumbent. In at least some example embodiments, the list of incumbents includes at least one additional high-power incumbent. In at least some example embodiments, the indication of the receiver saturation event associated with the new incumbent associated with the DPA for the CBRS shared spectrum band is received based on a failure of an attenuator of the radar detection sensor to eliminate the receiver saturation event for the radar detection sensor. In at least some example embodiments, the apparatus includes means for preventing reporting of the receiver saturation event to the ESC entity for preventing activation of protection by the ESC entity for the entire CBRS shared spectrum band as opposed to only the set of occupied channels of the CBRS shared spectrum band. In at least some example embodiments, the attenuation level of the attenuator at activation is a maximum possible attenuation level of the attenuator. In at least some example embodiments, the means for modulating the attenuator includes means for decreasing the attenuation level of the attenuator based on a determination that the radar detection sensor is not taken out of the receiver saturation event by a previous attenuation modulation operation performed for the attenuator. In at least some example embodiments, the attenuation level is decreased by half of a previous value of the attenuation level resulting from the previous attenuation modulation operation performed for the attenuator. In at least some example embodiments, the means for modulating the attenuator includes means for increasing the attenuation level of the attenuator based on a determination that the radar detection sensor is taken out of the receiver saturation event by a previous attenuation modulation operation performed for the attenuator. In at least some example embodiments, the attenuation level is increased by half of a previous value of the attenuation level resulting from the previous attenuation modulation operation performed for the attenuator. In at least some example embodiments, the means for modulating the attenuator includes means for decreasing the attenuation level of the attenuator based on a determination that the radar detection sensor is taken out of the receiver saturation event by a previous attenuation modulation operation performed for the attenuator and a determination that the set of occupied channels of the CBRS shared spectrum band is successfully identified. In at least some example embodiments, the attenuation level is decreased by half of a previous value of the attenuation level resulting from the previous attenuation modulation operation performed for the attenuator. In at least some example embodiments, the apparatus includes means for periodically performing a process for iteratively decreasing the attenuation level of the attenuator until detecting a new receiver saturation event or until the attenuation level of the attenuator reaches zero. In at least some example embodiments, the apparatus includes means for modulating, based on a determination that the new receiver saturation event is detected, the attenuator to identify a new attenuation level that eliminates the receiver saturation event and that permits identification of the set of occupied channels of the CBRS shared spectrum band. In at least some example embodiments, the apparatus includes means for deactivating the attenuator to determine whether the receiver saturation event is still present and updating the list of incumbents associated with the DPA for the CBRS shared spectrum band, while the attenuator is deactivated, to obtain an updated list of incumbents associated with the DPA for the CBRS shared spectrum band. In at least some example embodiments, the apparatus includes means for reactivating the attenuator based on detection of a new receiver saturation event while the attenuator is deactivated and means for modulating, based on the new receiver saturation event and the updated list of incumbents associated with the DPA for the CBRS shared spectrum band, the attenuator to identify a new attenuation level that eliminates the receiver saturation event and that permits identification of the set of occupied channels of the CBRS shared spectrum band. In at least some example embodiments, the attenuation level comprises a minimum attenuation level that eliminates the receiver saturation event and that permits identification of the set of occupied channels of the CBRS shared spectrum band. In at least some example embodiments, the CBRS shared spectrum band comprises a lower 100 MHz of the CBRS band.

### BRIEF DESCRIPTION OF THE DRAWINGS

The teachings herein can be readily understood by considering the following detailed description in conjunction with the accompanying drawings, in which:

FIG. 1 is a block diagram of a communication system according to some embodiments:

FIG. 2 is a block diagram of a network function virtualization (NFV) architecture according to some embodiments;

FIG. 3 is a block diagram illustrating an allocation of frequency bands and an access priority for incumbents, licensed users, and general access users according to some embodiments;

FIG. 4 is a block diagram of a communication system that implements tiered spectrum access according to some embodiments;

FIG. 5 is a block diagram of a communication system that implements a spectrum controller cloud to support deployment of private enterprise networks in a shared spectrum according to some embodiments;

FIG. 6 is a block diagram of a communication system including interfaces between CBSDs and an SAS according to some embodiments;

FIG. 7 is a map of the borders of the United States that illustrates a set of dynamic protection areas (DPAs) defined at different geographic locations within the United States according to some embodiments;

FIG. 8 is a block diagram of a communication system that implements an outer corrective loop, based on use of an external attenuator and a management module to enhance CBRS private enterprise cellular service availability and reliability within a DPA in the presence of a high-power incumbent, according to some embodiments;

FIG. 9 is a flow diagram of a method for providing enhanced availability and reliability of CBRS private enterprise cellular service in a shared spectrum system according to some embodiments;

FIG. 10 is a flow diagram of a method for providing enhanced availability and reliability of CBRS private enterprise cellular service in a shared spectrum system according to some embodiments;

FIG. 11 is a flow diagram of a method for providing enhanced availability and reliability of CBRS private enterprise cellular service in a shared spectrum system according to some embodiments; and

FIG. 12 depicts an example embodiment of a computer suitable for use in performing various functions presented herein.

To facilitate understanding, identical reference numerals have been used herein, wherever possible, in order to designate identical elements that are common among the various figures.

### DETAILED DESCRIPTION

The Federal Communication Commission (FCC) has begun offering bands of spectrum owned by federal entities for sharing with commercial operations. For example, newly issued FCC rules in 47 Code of Federal Regulations (CFR) Part 96 allows sharing of the 3550-3700 MHz Citizens Broadband Radio Service (CBRS) between incumbents and other operators. The CBRS operates according to a tiered access architecture that distinguishes between incumbents, operators that have received a priority access license (PAL) consistent with 47 CFR § 96.23, et seq., and general authorized access (GAA) operators that are authorized to implement one or more Citizens Broadband radio Service Devices (CBSDs) consistent with 47 CFR § 96.33, et seq. Incumbents, PAL licensees, and GAA operators are required to request access from a spectrum access system (SAS), which allocates frequency bands to the operators, e.g., for CBRS within the 3550-3700 MHz band. The frequency bands are allocated to the CBSDs associated with the operators within particular geographical areas and, in some cases, during particular time intervals. The SAS determines whether incumbents are present within corresponding geographical areas using an environmental sensing capability (ESC) that performs incumbent detection, e.g., using radar to detect the presence of a Navy ship in a port. Each SAS is able to serve multiple private enterprise networks that include a large number of CBSDs such as base stations, eNodeBs, microcells, picocells, and the like.

The tiered access architecture provides priority access to incumbents, which include Grandfathered Wireless Broadband Licensees that are authorized to operate on a primary basis on frequencies designated in 47 CFR § 96.11. When an incumbent is present in a particular geographical area, the incumbent is granted exclusive access to a portion of the CBRS spectrum. For example, if a Navy ship enters a port, communication systems on the ship are granted exclusive access to frequencies that may impact up to 20 MHz within the lower 100 MHz of the CBRS 3550-3700 MHz band. Operators that have received a PAL and GAA operators are required to vacate the band allocated to the ship. A PAL license grants exclusive access to a portion in the lower 100 MHz of the 3550-3700 MHz band within a predetermined geographical area as long as no incumbents have been allocated an overlapping portion of the 3550-3700 MHz band within the predetermined geographical area. The GAA operators are given access to a portion of the 3550-3700 MHz band within a geographic area as long as no incumbents or PAL licensees have been allocated an overlapping portion in the same geographic area during a concurrent time interval. The GAA operators are also required to share the allocated portion of the 3550-3700 MHz band if other GAA operators are allocated the same portion.

The tiered access architecture, as indicated above, provides priority access to incumbents which include naval ships. Currently, there are five different types of naval radars (two of them are currently operational, while the other three are not yet deployed but may be deployed in the coming years and could be tested around US naval bases prior to being deployed. Some of the new naval radars are wide band and could take up 20 MHz to 40 MHz of the bottom 100 MHZ of the CBRS shared spectrum when operational. A problem that has been observed in the southern California DPAs that is in close proximity to US Naval base is that periodically some very powerful naval incumbent is appearing that is causing the receiver chain of the ESC sensors to saturate, thereby rendering them un-operational. This causes the ESC sensor to not be able to detect the actual channels the dynamic naval incumbent is occupying out of the entire lower 100 MHz of the CBRS shared spectrum band. This forces the ESC sensor to declare the DPA activated for the entire 100 MHz of the CBRS shared spectrum where PAL channels are located. This, in turn, causes a private enterprise network outage for a non-deterministic period for any private enterprises which were operating using these PAL channels. The private enterprise customers of the tiered access architecture, as indicated earlier, paid millions of dollars to acquire PAL channels in the hopes of enhancing their CBRS private cellular network reliability and availability compared to the use of GAA channels (e.g., the FCC recently raised $4.7B from PAL channel auctions to make PAL channels available for use by private enterprise customers), so any unavailability of such PAL channels should be avoided as much as possible in order to prevent network outages for the private enterprise customers.

One solution to the network outages experienced by the private enterprise customers in the presence of certain low-power incumbents is currently designed into the ESC sensor. The ESC sensor has an onboard internal attenuator on its receiver RF chain which supports an inner corrective loop within the ESC sensor (which also may be referred to as an internal corrective loop as the loop is internal to the ESC sensor) which may be opportunistically employed to ensure that received signals from a naval incumbent will not cause its receiver RF chain to saturate and render it incapable of identifying which portion of the lower 100 MHz of the CBRS shared spectrum band the low-power naval incumbent is currently occupying. However, when a high-power incumbent arrives to the area, the inner corrective loop of the ESC sensor is unable to avoid the receiver saturation event and the ESC sensor eventually reports back to the ESC cloud entity a status indicating that the ESC sensor is facing a receiver saturation event due to the presence of a high-power incumbent. The ESC entity, upon receiving such an indication, can only overprotect the high-power incumbent, and relays to the SAS to activate the DPA across the entire lower 100 MHZ of the shared spectrum band in the affected DPA, thereby resulting in unavailability of PAL channels for use by private enterprise customers.

One potential solution to the network outages experienced by the private enterprise customers in the presence of certain incumbents, including high-power incumbents, is modification of the ESC sensor to compensate for such high-power incumbents. However, while modification of the ESC sensor might be a potential solution to the network outages experienced by the private enterprise customers in the presence of high-power incumbents, implementation of such a solution would likely take years to realize, leaving the private enterprise customers vulnerable to outages from high-power incumbents in the interim. For example, the ESC sensor went through a multi-year rigorous testing process by the US Department of Defense (DoD) and FCC before receiving certification to be commercially deployed and, thus, any hardware or software changes to the already certified ESC sensors will require a new multi-year certification process, which is not a viable option from the perspective of the private enterprise customers that use the PAL channels for their mission critical operations.

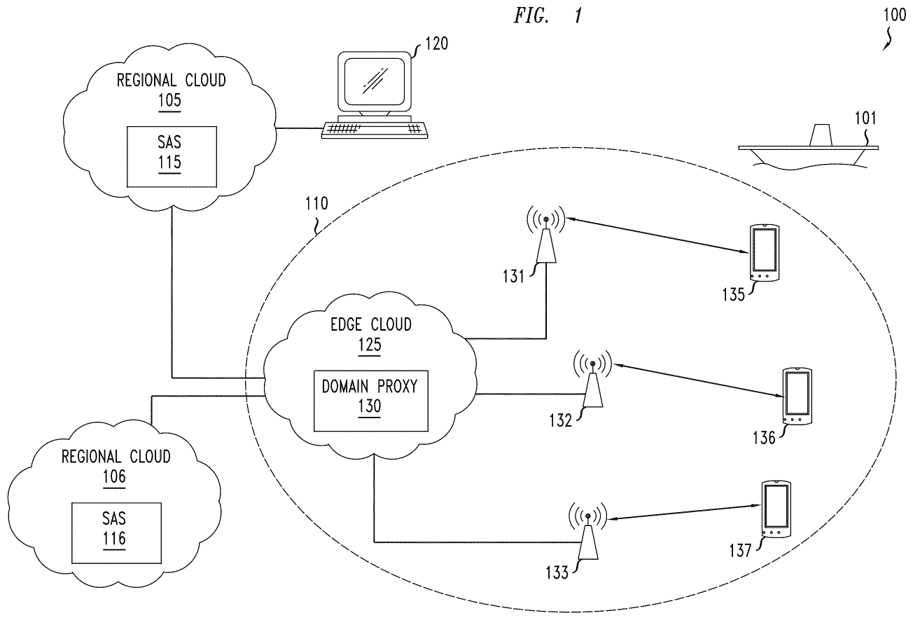

FIGS. 1-12 disclose embodiments of techniques for providing enhanced availability and reliability of CBRS private enterprise cellular service in a DPA of a shared spectrum system, obviating the need for declaring the DPA activated for the entire 100 MHz of the CBRS shared spectrum when high-power incumbents are present in the DPA.

FIGS. 1-12 disclose embodiments in which an external attenuator may be added between the externally mounted receiver antenna port and the ESC sensor and the control computer for the ESC sensor is configured to support an outer corrective loop for activating and modulating the external attenuator in a manner supporting enhanced availability and reliability of CBRS private enterprise cellular service in a DPA when a high-power incumbent is present. The ESC sensor can detect within microseconds if the receiver chain becomes saturated due to a high-power receive signal from a high-power incumbent and, in response to such a receiver saturation event, may initiate internal corrective actions based on an internal corrective loop to try to overcome the receiver saturation event. The ESC sensor, if the internal corrective loop is unable to overcome the receiver saturation event, reports the receiver saturation event to the control computer; however, the control computer, rather than reporting the receiver saturation event to the ES cloud entity on the regional cloud (since doing so would trigger a corresponding DPA activation event that would be forwarded to the SAS to block the usage of the entire bottom 100 MHZs of the CBRS band within the DPA until the DPA event is cleared by the ESC sensor), will activate the outer corrective loop to attempt to take the ESC sensor out of the receiver saturation event while also enabling identification of the channel(s) of the CBRS band that are being used by incumbents so that the DPA activation may be initiated only over the channel(s) of the CBRS band that are being used by the incumbents, thereby permitting the private enterprise customers to continue to use the other channels of the CBRS band.

FIGS. 1-12 disclose embodiments in which, as indicated above, the control computer, in response to receiving an indication of a receiver saturation event from the ESC sensor when a high-power incumbent arrives in the DPA, will activate the outer corrective loop to attempt to take the ESC sensor out of the receiver saturation event while also enabling identification of the channel(s) of the CBRS band that are being used by incumbents so that the DPA activation may be initiated only over the channel(s) of the CBRS band that are being used by the incumbents. The control computer may control the outer corrective loop in a manner for taking the ESC sensor out of the receiver saturation event and identifying the channel(s) of the CBRS band that are being used by the high-power incumbent so that the DPA activation may be initiated only over the channel(s) of the CBRS band that are being used by the high-power incumbent, thereby permitting the private enterprise customers to continue to use the other channels of the CBRS band. The control computer also may control the outer corrective loop not only in a manner for taking the ESC sensor out of the receiver saturation event and identifying the channel(s) of the CBRS band that are being used by the high-power incumbent, but also in a manner for identifying any channel(s) of the CBRS band that are being used by any other incumbents that also may be located within the DPA while the high-power incumbent is present within the DPA, thereby permitting the private enterprise customers to continue to use the other channels of the CBRS band.

It will be appreciated that the foregoing embodiments, as well as various other related embodiments, may be further understood by way of reference to FIGS. 1-12, which are discussed further hereinbelow.

FIG. 1 is a block diagram of a communication system 100 according to some embodiments. The communication system 100 operates in accordance with the FCC rules set forth in 47 Code of Federal Regulations (CFR) Part 96, which allows sharing of the 3550-3700 MHz Citizens Broadband Radio Service (CBRS) between incumbents and other operators. However, some embodiments of the communication system 100 operate in accordance with other rules, standards, or protocols that support sharing of a frequency band between incumbents and other devices such that the frequency band is available for exclusive allocation to an incumbent device if the incumbent device is present in a geographic area. In that case, the other devices are required to vacate any portion of the frequency band that overlaps with another portion of the frequency band that is allocated to the incumbent device. For example, if the communication system 100 is deployed (at least in part) proximate a port and a Navy ship such as an aircraft carrier 101 arrives in the port, devices in a geographic area proximate the port that are providing wireless connectivity in a portion of the frequency band allocated to the aircraft carrier 101 are required to vacate the portion of the frequency band to provide the aircraft carrier 101 with exclusive access to the frequency band within the geographic arca.

The communication system 100 includes a regional cloud 105 that provides cloud-based support for a private enterprise network 110. Some embodiments of the regional cloud 105 include one or more servers that are configured to provide operations and maintenance (O&M) management, a customer portal, network analytics, software management, and central security for the private enterprise network 110. The regional cloud 105 also includes a Spectrum Access System (SAS) 115 to allocate frequency bands to operators, e.g., to the private enterprise network 110 for CBRS within the 3550-3700 MHz band. The communication system 100 also includes another regional cloud 106 that includes an SAS 116. In the illustrated embodiment, the regional clouds 105, 106 are located at different geographic locations and are therefore used to provide geo-redundancy. The SAS 116 is therefore referred to as a geo-redundant SAS 116 in some cases. The geo-redundant instances of the SAS 115, 116 communicate with each other over an SAS-SAS interface (not shown in FIG. 1 of the interest of clarity). For example, the geo-redundant instances of the SAS 115, 116 exchange status information at a determined time interval such as once every 24 hours. Other SAS-SAS interfaces (not shown in FIG. 1 in the interest of clarity) are also used to exchange status information with other SAS instances associated with other vendors at the predetermined time interval. Some embodiments of the communication system 100 include additional regional clouds and SAS instances, which may or may not be geo-redundant and communicate over corresponding SAS-SAS interfaces. The SASs 115, 116 can serve multiple private enterprise networks, although a single private enterprise network 110 is shown in FIG. 1 in the interest of clarity. Operation of the SASs 115, 116 is disclosed in more detail below.

The regional clouds 105, 106 are configured via user interface portals to one or more external computers 120, although only one is shown in FIG. 1 in the interest of clarity. For example, the external computer 120 provides a customer user interface portal for service management, a digital automation cloud management user interface portal, and an SAS user interface portal that is used to configure the SASs 115, 116.

The private enterprise network 110 includes an edge cloud 125 that communicates with the regional clouds 105, 106 to support a plug-and-play deployment of the private enterprise network 110. Some embodiments of the edge cloud 125 support auto configuration and self-service, industrial protocols, local connectivity with low latency, LTE/5G based communication and local security, high availability, and other optional applications for the private enterprise network 110. In the illustrated embodiment, the edge cloud 125 implements a domain proxy 130 that provides managed access and policy control to a set of CBSDs 131, 132, 133 that are implemented using base stations, base station routers, mini-macrocells, microcells, indoor/outdoor picocells, femtocells, and the like. As used herein, the term “base station” refers to any device that provides wireless connectivity and operates as a CBSD in the private enterprise network 110 as either category A CBSD (Indoor), category B CBSD (outdoor), or customer premises equipment (CPE). The CBSDs 131, 132, 133 are therefore referred to herein as the base stations 131, 132, 133 and collectively as “the base stations 131-133.” Some embodiments of the domain proxy 130 are implemented in the regional clouds 105, 106.

The domain proxy 130 mediates between the SASs 115, 116 and the base stations 131-133. In order to utilize the shared spectrum, the base stations 131-133 transmit requests towards one of the SASs 115, 116 to request allocation of a portion of a frequency band. As discussed herein, the domain proxy 130 identifies one of the SASs 115, 116 as a primary SAS that is initially used to support communication in the shared spectrum and the other one of the SASs 115, 116 as a secondary SAS, which is used as a fallback in case of a disruption of service to the primary SAS. The requests include information identifying the portion of the frequency band such as one or more channels, a geographic area corresponding to a coverage area of the requesting base station, and, in some cases, a time interval that indicates when the requested portion of the frequency band is to be used for communication. In the illustrated embodiment, the coverage area of the base stations 131-133 corresponds to the area encompassed by the private enterprise network 110. Some embodiments of the domain proxy 130 reduce the signal load between the domain proxy 130 and the SASs 115, 116 by aggregating requests from multiple base stations 131-133 into a smaller number of messages that are transmitted from the domain proxy 130 to the SASs 115, 116. The base stations 131-133 provide wireless connectivity to corresponding user equipment 135, 136, 137 (collectively referred to herein as “the user equipment 135-137”) in response to the SAS 115 allocating portions of the frequency band to the base stations 131-133.

The requests transmitted by the base stations 131-133 do not necessarily include the same information. Some embodiments of the requests from the base stations 131-133 include information indicating different portions of the frequency band, different geographic areas, or different time intervals. For example, the base stations 131-133 request portions of the frequency band for use in different time intervals if the private enterprise network 110 is deployed in a mall or shopping center and the base stations 131-133 are used to provide wireless connectivity within different stores that have different operating hours. The domain proxy 130 therefore manages the base stations 131-133 using separate (and potentially different) policies on a per-CBSD basis. In some embodiments, the domain proxy 130 accesses the policies for the base stations 131-133 in response to receiving a request from the corresponding base station 131-133. The domain proxy 130 determines whether the base station 131-133 is permitted to access the SAS 115 based on the policy, e.g., by comparing information in the policy to information in one or more mandatory fields of the request. The domain proxy 130 selectively provides the requests to the SASs 115, 116 depending on whether the base station 131-133 is permitted to access the SASs 115, 116. If so, the request is transmitted to the SASs 115, 116 or aggregated with other requests for transmission to the SASs 115, 116. Otherwise, the request is rejected.

The domain proxy 130 monitors connections with the geo-redundant SASs 115, 116 to determine whether the instances are available. As discussed herein, the geo-redundant SASs 115, 116 can become unavailable due to a failure in a backhaul, a natural disaster, a DDOS attack, or other scenarios. The domain proxy 130 is therefore able to instantiate a local SAS that supports the base stations 131-133 when the geo-redundant SASs are unavailable. In response to detecting unavailability of the geo-redundant SASs 115, 116, the local SAS is configured to respond to heartbeat requests received from the base stations 131-133. Some embodiments of the local SAS are also configured to provide information indicating valid channels in response to a spectrum inquiry message received from the base stations 131-133 and approve grant requests for channels in a valid channel set. The local SAS also attempts to establish a connection with an environmental sensing capability (ESC, which is not shown in FIG. 1 in the interest of clarity) in response to the geo-redundant SASs 115, 116 becoming unavailable. The actions of the local SAS depend upon the frequency channels allocated to (or requested by) the base stations 131-133, the presence or absence of an incumbent, and whether the local SAS is able to establish the connection with the ESC, as discussed in detail below.

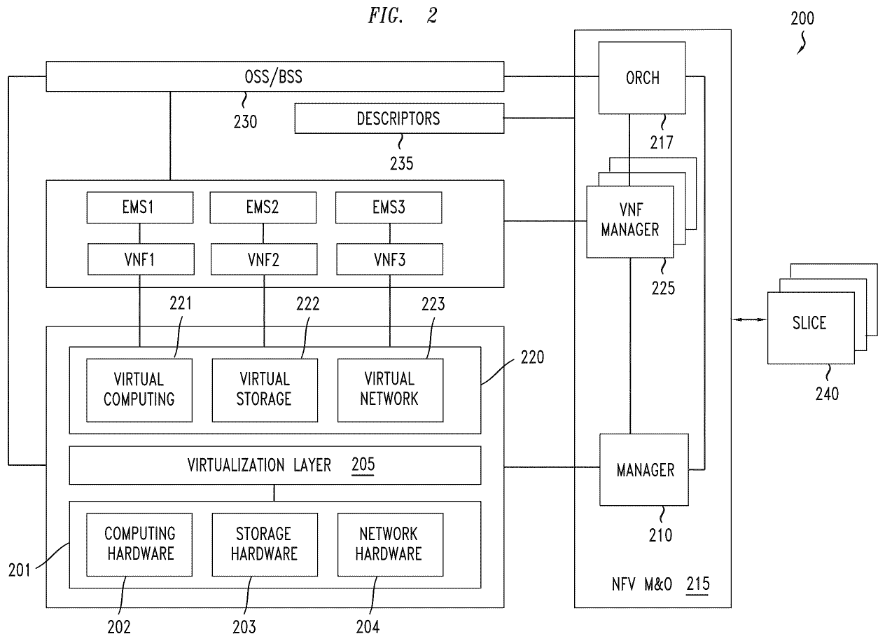

FIG. 2 is a block diagram of a network function virtualization (NFV) architecture 200 according to some embodiments. The NFV architecture 200 is used to implement some embodiments of the communication system 100 shown in FIG. 1. For example, the NFV architecture 200 provides the physical resources used to implement the domain proxy 130 shown in FIG. 1, as well as the physical resources used to instantiate the local SAS and other instances of the SAS 115, 116. The NFV architecture 200 includes hardware resources 201 including computing hardware 202 such as one or more processors or other processing units, storage hardware 203 such as one or more memories, and network hardware 204 such as one or more transmitters, receivers, or transceivers. A virtualization layer 205 provides an abstract representation of the hardware resources 201. The abstract representation supported by the virtualization layer 205 can be managed using a virtualized infrastructure manager 210, which is part of the NFV management and orchestration (M&O) module 215. Some embodiments of the manager 210 are configured to collect and forward performance measurements and events that may occur in the NFV architecture 200. For example, performance measurements may be forwarded to an orchestrator (ORCH) 217 implemented in the NFV M&O 215. The hardware resources 201 and the virtualization layer 205 may be used to implement virtual resources 220 including virtual computing 221, virtual storage 222, and virtual networking 223.

Virtual networking functions (VNF1, VNF2, VNF3) run over the NFV infrastructure (e.g., the hardware resources 201) and utilize the virtual resources 220. For example, the virtual networking functions (VNF1, VNF2, VNF3) may be implemented using virtual machines supported by the virtual computing resources 221, virtual memory supported by the virtual storage resources 222, or virtual networks supported by the virtual network resources 223. Element management systems (EMS1, EMS2, EMS3) are responsible for managing the virtual networking functions (VNF1, VNF2, VNF3). For example, the element management systems (EMS1, EMS2, EMS3) may be responsible for fault and performance management. In some embodiments, each of the virtual networking functions (VNF1, VNF2, VNF3) is controlled by a corresponding VNF manager 225 that exchanges information and coordinates actions with the manager 210 or the orchestrator 217.

The NFV architecture 200 may include an operation support system (OSS)/business support system (BSS) 230. The OSS/BSS 230 deals with network management including fault management using the OSS functionality. The OSS/BSS 230 also deals with customer and product management using the BSS functionality. Some embodiments of the NFV architecture 200 use a set of descriptors 235 for storing descriptions of services, virtual network functions, or infrastructure supported by the NFV architecture 200. Information in the descriptors 235 may be updated or modified by the NFV M&O 215.

The NFV architecture 200 can be used to implement network slices 240 that provide user plane or control plane functions. A network slice 240 is a complete logical network that provides communication services and network capabilities, which can vary from slice to slice. User equipment can concurrently access multiple slices. Some embodiments of user equipment provide Network Slice Selection Assistance Information (NSSAI) parameters to the network to assist in selection of a slice instance for the user equipment. A single NSSAI may lead to the selection of several slices. The NFV architecture 200 can also use device capabilities, subscription information and local operator policies to do the selection. An NSSAI is a collection of smaller components, Single-NSSAIs (S-NSSAI), which each include a Slice Service Type (SST) and possibly a Slice Differentiator (SD). Slice service type refers to an expected network behavior in terms of features and services (e.g., specialized for broadband or massive IoT), while the slice differentiator can help selecting among several network slice instances of the same type, e.g. to isolate traffic related to different services into different slices.

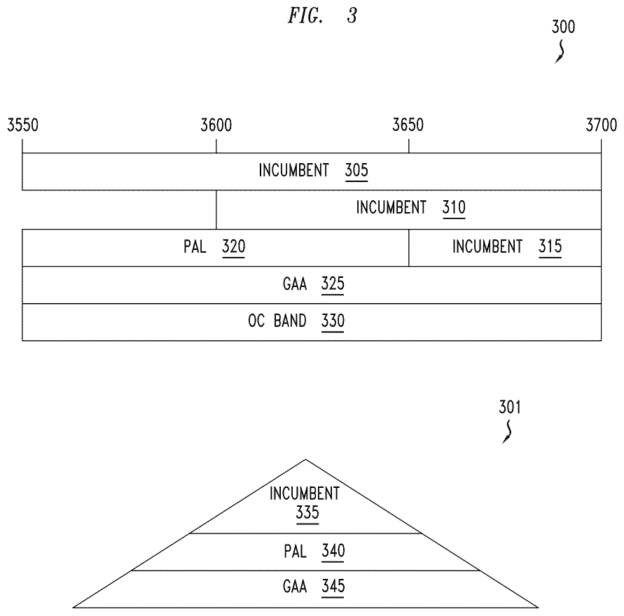

FIG. 3 is a block diagram illustrating an allocation 300 of frequency bands and an access priority 301 for incumbents, licensed users, and general access users according to some embodiments. The allocation 300 and the access priorities 301 are used to determine whether CBSDs such as the base stations 131-133 shown in FIG. 1 are given permission to establish a wireless communication links in portions of the frequency band. The frequency band extends from 3550 MHz to 3700 MHz and therefore corresponds to the spectrum allocated for CBRS. An SAS such as the SASs 115, 116 shown in FIG. 1 allocates portions of the frequency band to devices for providing wireless connectivity within a geographic area. For example, the SAS can allocate 20-40 MHz portions of the frequency band to different devices for use as communication channels.

Portions of the frequency band are allocated to incumbent federal radio location devices, such as Navy ships, from the block 305, which corresponds to all of the frequencies in the available frequency band. Portions of the frequency band are allocated to incumbent FSS receive-only earth stations from the block 310. Portions of the frequency band are allocated to grandfathered incumbent wireless broadband services from the block 315. As discussed herein, the portions of the frequency band are allocated from the blocks 305, 310, 315 for exclusive use by the incumbent.

Operators that have received a priority access license (PAL) consistent with 47 CFR § 96.23, et seq. are able to request allocation of portions of the frequency band in the block 320. The portion of the frequency band that is allocated to an operator holding a PAL is available for exclusive use by the operator in the absence of any incumbents in an overlapping frequency band and geographic area. For example, the SAS can allocate a PAL channel in any portion of the lower 100 MHz of CBRS band as long as it is not pre-empted by the presence of an incumbent. Portions of the frequency band within the block 325 are available for allocation to general authorized access (GAA) operators that are authorized to implement one or more CBSDs consistent with 47 CFR § 96.33, et seq. The GAA operators provide wireless connectivity in the allocated portion in the absence of any incumbents or PAL licensees on an overlapping frequency band and geographic area. The GAA operators are also required to share the allocated portion with other GAA operators, if present. Portions of the frequency band within the block 330 are available to other users according to protocols defined by the Third Generation Partnership Project (3GPP).

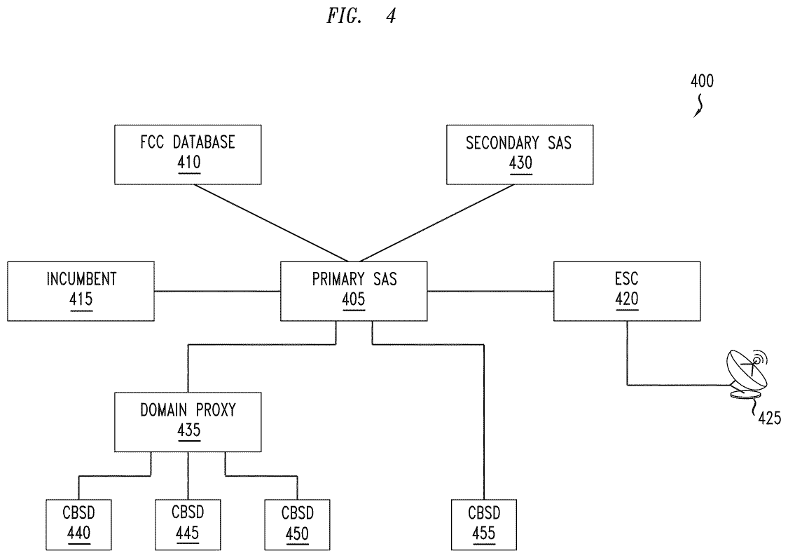

The access priority 301 indicates that incumbents have the highest priority level 335. Incumbents are therefore always granted exclusive access to a request to portion of the frequency band within a corresponding geographic area. Lower priority operators are required to vacate the portion of the frequency band allocated to the incumbents within the geographic area. The access priority 301 indicates that PAL licensees have the next highest priority level 340, which indicates that PAL licensees receive exclusive access to an allocated portion of the frequency band in the absence of any incumbents. The PAL licensees are also entitled to protection from other PAL licensees within defined temporal, geographic, and frequency limits of their PAL. The GAA operators (and, in some cases, operators using other 3GPP protocols) received the lowest priority level 345. The GAA operators are therefore required to vacate portions of the frequency band that overlap with portions of the frequency band allocated to either incumbents or PAL licensees within an overlapping geographic area. FIG. 4 is a block diagram of a communication system 400 that implements tiered spectrum access according to some embodiments. In the illustrated embodiment, the communication system 400 implements tiered spectrum access in the 3550-3700 CBRS band via a WInnForum architecture. The communication system 400 includes an SAS 405 that performs operations including incumbent interference determination and channel assignment, e.g., for CBRS channels shown in FIG. 3. In the illustrated embodiment, the SAS 405 is a primary SAS. An FCC database 410 stores a table of frequency allocations that indicate frequencies allocated to incumbent users and PAL licensees. An informing incumbent 415 provides information indicating the presence of the incumbent (e.g., a coverage area associated with the incumbent, and allocated frequency range, a time interval, and the like) to the SAS 405. The SAS 405 allocates other portions of the frequency range to provide exclusive access to the informing incumbent 415 within the coverage area. An environmental sensing capability (ESC) 420 performs incumbent detection to identify incumbents using a portion of a frequency range within the geographic area, e.g., using a radar sensing apparatus 425. Some embodiments of the SAS 405 are connected to other SAS 430 via corresponding interfaces so that the SAS 405, 430 coordinate allocation of portions of the frequency range in geographic areas or time intervals. In the illustrated embodiment, the SAS 430 is a secondary SAS that is geo-redundant with the primary SAS 415.

A domain proxy 435 mediates communication between the SAS 405 and one or more CBSD 440, 445, 450 via corresponding interfaces. The domain proxy 435 receives channel access requests from the CBSDs 440, 445, 450 and verifies that the CBSDs 440, 445, 450 are permitted to request channel allocations from the SAS 405. The domain proxy 435 forwards requests from the permitted CBSDs 440, 445, 450 to the SAS 405. As discussed herein, the domain proxy 435 monitors availability of the primary SAS 415 (as well as availability of one or more geo-redundant SAS) and instantiates a local SAS in response to the primary SAS 415 and any geo-redundant SASs becoming unavailable. The local SAS selectively responds to heartbeat messages from the CBSD 440, 445, 450.

In some embodiments, the domain proxy 435 aggregates the requests from the permitted CBSDs 440, 445, 450 before providing the aggregated request to the SAS 405. The domain proxy 435 aggregates requests based on an aggregation function that is a combination of two parameters: (1) a maximum number of requests that can be aggregated into a single message and (2) a maximum wait duration for arrival of requests that are to be aggregated into a single message. For example, if the wait duration is set to 300 ms and the maximum number of requests is 500, the domain proxy accumulates receive requests until the wait duration reaches 300 ms or the number of accumulated requests which is 500, whichever comes first. If only a single request arrives within the 300 ms wait duration, the “aggregated” message includes a single request.

Thus, from the perspective of the SAS 405, the domain proxy 435 operates as a single entity that hides or abstracts presence of the multiple CBSDs 440, 445, 450 and conveys communications between the SAS 405 and the CBSDs 440, 445, 450. One or more CBSD 455 (only one shown in the interest of clarity) are connected directly to the SAS 405 and can therefore transmit channel access requests directly to the SAS 405. Additional discussion of this architecture is provided in Appendix B, from the Wireless Innovation Forum (WinnForum), entitled “Requirements for Commercial Operation in the U.S. 3550-3700 MHZ Citizens Broadband Radio Service Band”, Working Document WINNF-TS-0112, Version V1.4.130, Jan. 16, 2018, which is incorporated by reference herein in its entirety.

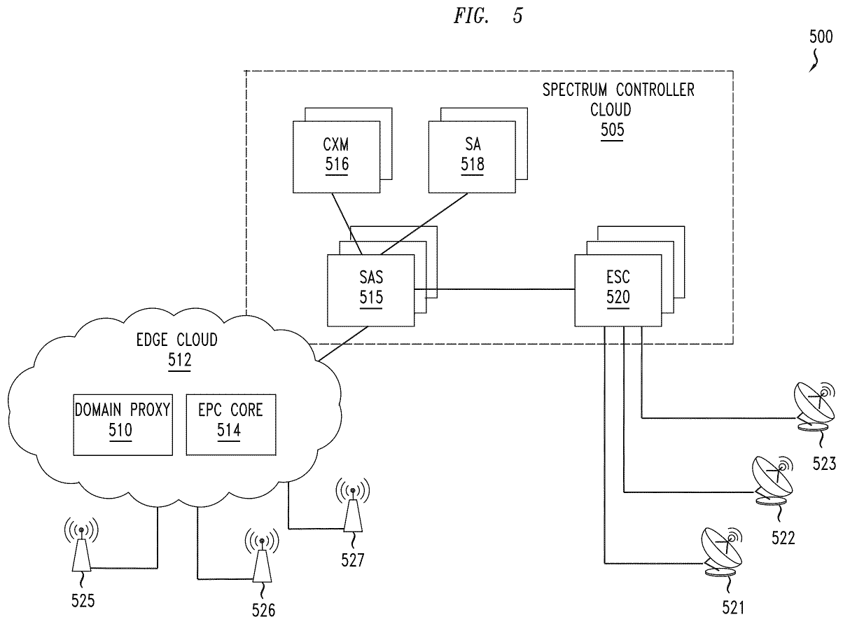

FIG. 5 is a block diagram of a communication system 500 that implements a spectrum controller cloud 505 to support deployment of private enterprise networks in a shared spectrum according to some embodiments. The spectrum cloud controller 505 instantiates a domain proxy 510. In the illustrated embodiment, the domain proxy is situated on an edge cloud 512 to support mission control applications that require high network availability. In other embodiments, the domain proxy 510 is implemented at other locations in the communication system 500. For example, the domain proxy 510 can be implemented a part of a regional cloud to manage one or more different edge cloud infrastructures. The domain proxy 510 manages the edge cloud 512, which also contains a localized EPC core 514. The EPC core 514 provides functionality including LTE EPC operation support system (OSS) functionality, analytics such as traffic analytics used to determine latencies, and the like.

The spectrum controller cloud 505 instantiates multiple SAS instances 515 that support one or more private enterprise networks. Although not shown in FIG. 5, the SAS instances 515 can be connected to other SAS instances, e.g., in other clouds, via corresponding interfaces. Some embodiments of the SAS instances 515 are geo-redundant with each other. One of the SAS instances 515 can therefore be selected as a primary SAS and another one of the SAS instances 515 can be selected as a corresponding secondary SAS. Coexistence management (CXM) functions 516 and spectrum analytics (SA) functions 518 are also instantiated in the spectrum controller cloud 505.

One or more ESC instances 520 are instantiated and used to detect the presence of incumbents. In the illustrated embodiment, standalone ESC sensors 521, 522, 523 (collectively referred to herein as “the sensors 521-523”) are used to monitor a frequency band to detect the presence of an incumbent such as a Navy ship near a port or harbor. The ESC instances 520 notify the corresponding instance of the SAS 515 in response to detecting the presence of an incumbent in a corresponding geographic area. The SAS 515 is then able to instruct non-incumbent devices that serve the geographic area to vacate portions of the spectrum overlapping with the spectrum allocated to the incumbent, e.g., by defining a DPA in terms of a frequency band in a geographic area reserved for the incumbent.

One or more base stations 525, 526, 527 (collectively referred to herein as “the base stations 525-527”) in a private enterprise network communicate with one or more of the domain proxies 510 and the SAS instances 515 via an evolved packet core (EPC) cloud 530. The base stations 525-527 have different operating characteristics. For example, the base station 525 operates according to a PAL in the 3.5 GHz frequency band, the base station 526 operates according to GAA in the 3.5 GHz frequency band, and the base station 525 operates according to a PAL and GAA in the 3.5 GHz frequency band. The base stations 525-527 are configured as Category A (indoor operation with a maximum power of 30 dBm), Category B (outdoor operation with a maximum power of 47 dBm), or CPE. However, in other embodiments, one or more of the base stations 525-527 are configured as either Category A, Category B, or CPE.

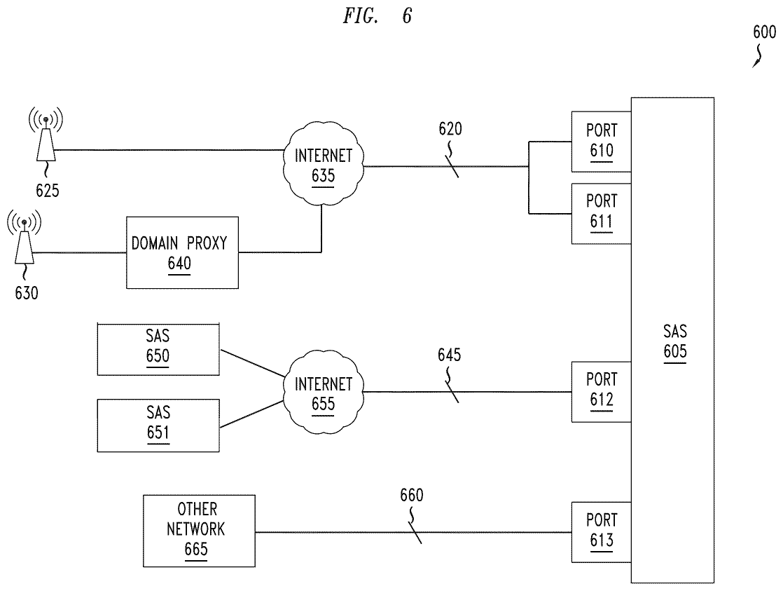

FIG. 6 is a block diagram of communication system 600 including interfaces between CBSDs and an SAS 605 according to some embodiments. The SAS 605 is used to implement some embodiments of the SAS 115 shown in FIG. 1, the SAS 405, 430 shown in FIG. 4, and the instances of the SAS 515 shown in FIG. 5. The SAS 605 includes ports 610, 611, 612, 613 (collectively referred to herein as “the ports 610-613”) that provide access to the SAS 605. In the illustrated embodiment, the SAS 605 is selected as a primary SAS.

An interface 620 supports communication between the SAS 605 and CBSDs 625, 630 via a network such as the Internet 635 and the ports 610, 611. The CBSD 625 is connected directly to the SAS 605 via the interface 620. The CBSD 630 is connected to the SAS 605 via a domain proxy 640 that is connected to the SAS 605 by the interface 620. The domain proxy 640 corresponds to some embodiments of the domain proxy 130 shown in FIG. 1, the domain proxy 435 shown in FIG. 4, and the instances of the domain proxy 510 shown in FIG. 5. An interface 645 supports communication between the SAS 605 and one or more other SASs 650, 651 (only one shown in FIG. 6 in the interest of clarity) via a network such as the Internet 655 and the port 612. The SASs 650, 651 can be owned and operated by other providers. Some embodiments of the SASs 650, 651 are selected as secondary SAS to support the primary SAS 605. An interface 660 supports communication between the SAS 605 and one or more other networks 665 (only one shown in FIG. 6 in the interest of clarity) via the port 613.

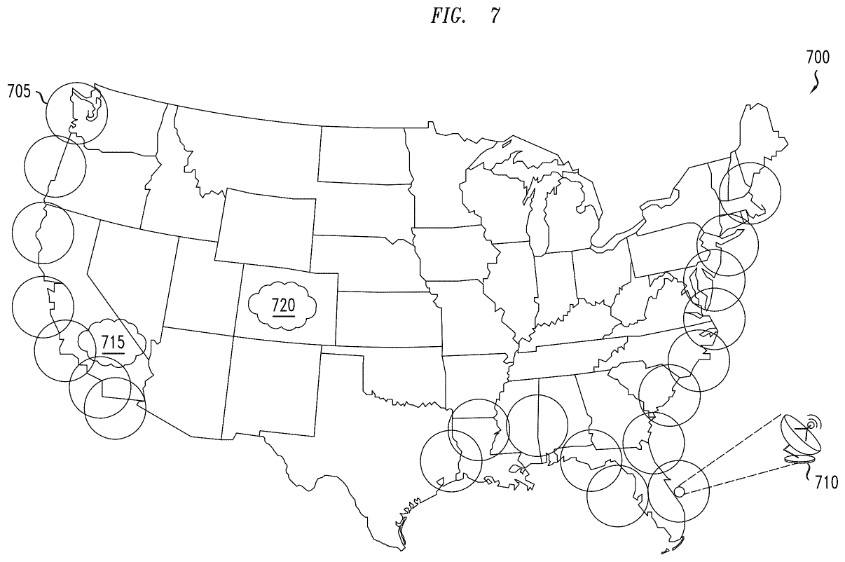

FIG. 7 is a map 700 of the borders of the United States that illustrates a set of dynamic protection areas (DPAs) defined at different geographic locations within the United States according to some embodiments. The DPAs 705 (only one indicated by a reference numeral in the interest of clarity) are typically, but not necessarily, defined near coastal regions to protect incumbents such as Navy ships. A DPA 705 can only be deactivated by an operational ESC sensor and consequently any communication system that uses the CBRS spectrum must include an ESC sensor, such as the ESC sensor 710, which is configured to operate as a naval radar detection sensor (which also may be referred to more generally herein as a radar detection sensor), to have full access to the CBRS spectrum. The ESC sensor 710 is also required to maintain an exchange of heartbeat messages with the ESC cloud that in turn connects with one or more SAS instances to verify that the ESC sensor 710 within the DPA 705 is operational. If there are no operational ESC sensors deployed within a DPA, FCC rules require that the DPA must be activated throughout the lower 100 MHz of the CBRS spectrum. In this case, a DPA-enabled SAS assumes that the incumbent is present in the entire lower 100 MHZ CBRS band. Based on this assumption, the DPA-enabled SAS takes into consideration the antenna height, tilt, distance from the ESC sensor and coastline of each CBSD (category A or category-B to determine if an appropriate channel grant and transmit power may be allocated for each CBSD for operation within the activated DPA.

Private enterprise networks 715, 720 are deployed to provide service in corresponding geographic areas. In the illustrated embodiment, the private enterprise network 715 is deployed approximate a coastal region and overlaps with one or more DPAs. The private enterprise network 720 is deployed at an inland location and does not overlap with the DPAs shown in FIG. 7. As discussed herein, status information is exchanged between SAS instances at a predetermined time interval, such as every 24 hours. The SAS instances generate configuration information for the CBSDs that are under their control based on the status information. The configurations are considered valid for the predetermined time interval, e.g., configurations of CBSDs in the private enterprise networks 715, 720 remain valid for 24 hours after the exchange of status information between corresponding SAS instances.

Unlike licensed spectrum, where the spectrum is never taken away, there are many different scenarios possible under which the shared spectrum may be taken away from the CBSDs operating in that shared spectrum frequency band. If no replacement channel is granted to the CBSDs by the SAS, this may result in a CBRS cellular network outage impacting mission critical operation of private enterprise customers within the impacted DPA. One such scenario is the sudden, dynamic appearance of one or more naval cruisers along the coastline, where each of the naval cruisers may be utilizing one of the five different types of naval radars that operate in the lower 100 MHz of the CBRS shared spectrum. It is the responsibility of the ESC sensor to detect the presence of all dynamic naval radar incumbents within the DPA within which the ESC is deployed for the bottom 100 MHz CBRS spectrum and to notify the presence of the naval radar incumbents to the SAS. Within 60 seconds of such dynamic incumbent detection, SAS must relocate any CBSDs that were operating on the affected bottom 100 MHz channels to alternate new channels (if available), otherwise the CBSDs are left with no channel grants. During this channel relocation process, it is also possible that the new channel grant from the SAS may come only with a much lower transmit equivalent isotropic radiated power (EIRP) allowance than what the CBSD was previously operating with on its dedicated PAL channel, which may also negatively impact the mission critical operations of the CBRS enterprise network due to drastic reduction of the CBSD coverage arca.

For proper operation of the ESC sensor, the WINNF standards mandate an ESC CBRS cellular Quiet Zone protection from nearby deployed CBSDs. This CBRS cellular Quiet Zone protection for ESC sensor is 40 km for CAT-A (indoor) CBSDs and 80 km for CAT-B (outdoor) CBSDs. There are multiple SAS operators with their own dedicated ESC service. If each chooses to deploy one or more ESC sensors within a DPA that typically has one of the highest population densities in US, this will result in serious black out (Quiet zones) regions for CBRS operation within a DPA. So, besides significantly increasing the capital expenditure (CAPEX)/operational expenditure (OPEX) cost of running an ESC service with multiple ESC sensors per DPA, there are consequences on severely limiting the CBRS cellular service due to the ESC Quiet zone protection regions. Due to these considerations, the ESC sensors are typically mounted at higher elevation (such as on remote mountaintops) where they may have an unobstructed view of the entire DPA for proper DPA coverage without severely limiting the CBRS service in the vicinity due to ESC Quite zone protection requirements. However, this consequently also makes them prone to RF receiver saturation events if a high-power radar beam directly lit up the receiver antenna port of the ESC sensor.

In the existing tiered access architecture, each ESC sensor forwards the incumbent detection event to the ESC cloud. The ESC sensor can detect within microseconds if its receiver chain gets saturated due to a high-power receive signal. Despite taking internal corrective actions for a time delta T (in seconds) via an internal, on-board receiver path attenuator (inner corrective loop) to get out of the receiver saturation event, the ESC sensor must report this receiver saturation event to the ESC cloud. As per the compliance rule for over-protecting the incumbent, since the ESC sensor was unable to correctly identify which channels of the lower 100 MHz CBRS band the high-power naval incumbent was occupying, the ESC cloud must activate a DPA event towards SAS, thereby taking out all 10 channels of the lower 100 MHZ CBRS band and, thus, impacting all PAL channels within the DPA. This ESC receiver saturation event has been observed by the ESC sensors of SAS operators in the southern California DPAs where the US San Diego Naval base is located. There have been instances where such high-power naval incumbents remain present for prolonged periods of time (e.g., several days or longer), thereby impacting the entire lower 100 MHz of the CBRS band and all PAL channels, thereby causing extended CBRS private cellular network operation outages within the impacted DPA. As discussed further hereinbelow, various example embodiments presented herein are configured to address this issue based on techniques for obviating the need to declare the DPA activated for the entire 100 MHz of the CBRS shared spectrum when high-power incumbents are present in the DPA, thereby providing enhanced availability and reliability of CBRS private enterprise cellular service in the DPA of the shared spectrum system.

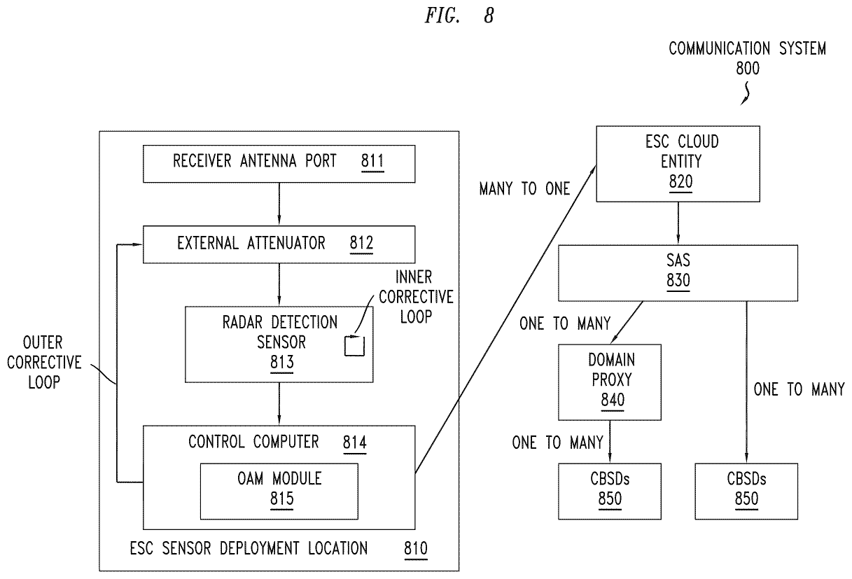

FIG. 8 is a block diagram of a communication system that implements an outer corrective loop, based on use of an external attenuator and a management module to enhance CBRS private enterprise cellular service availability and reliability within a DPA in the presence of a high-power incumbent, according to some embodiments.

As illustrated in FIG. 8, communication system 800 includes an ESC sensor deployment location 810 for a DPA, an ESC cloud entity 820, a SAS 830, a domain proxy 840, and CBSDs 850. The ESC sensor deployment location 810 is communicatively connected to the ESC cloud entity 820 to support CBRS private enterprise cellular service availability and reliability within the DPA. It will be appreciated that the operation of the ESC cloud entity 820, the SAS 830, the domain proxy 840, and the CBSDs 850 may be further understood by way of reference to FIGS. 1-7 and that the operation of ESC cloud entity 820 and SAS 830 are discussed further within the context of FIG. 8. The ESC sensor deployment location 810 includes a receiver antenna port 811, an external attenuator 812, a radar detection sensor 813, and a control computer 814 having an operations, administration, and maintenance (OAM) module 815 disposed thereon.

The ESC sensor deployment location 810 may support various ESC sensing related capabilities. The receiver antenna port 811 is configured to receive radar signals and direct the received radar signals toward the radar detection sensor 812 via the external attenuator 812. The external attenuator 812 is disposed between the receiver antenna port 811 and the radar detection sensor 813, and is configured to support attenuation of the received radar signal. For example, the external attenuator 812 may be a programmable digital attenuator including one or more bidirectional step attenuators with calibrated operation to support step-wise raising and lowering of attenuation levels to support attenuation of the received radar signals for overcoming receiver saturation events and supporting enhanced CBRS private enterprise cellular service availability and reliability within a DPA. The radar detection sensor 813 is configured to support various radar signal handling capabilities, such as radar signal detection, attenuation, identification, or the like, as well as various combinations thereof. It will be appreciated that the radar detection sensor 813 is an FCC-certified radar detection sensor. The computer 814 is configured to provide various control functions, including control functions for controlling operation of elements at the ESC sensor deployment location 810 to detect and compensate for radar signals related to supporting CBRS private enterprise cellular service availability and reliability within the DPA and control functions for interacting with the ESC cloud entity 820 to support protection of incumbents in the DPA in order to support CBRS private enterprise cellular service availability and reliability within the DPA. The OAM module 815 is configured to enable the computer 814 to support additional functions which enable the ESC sensor deployment location 810 to enhance CBRS private enterprise cellular service availability and reliability within the DPA in the presence of high-power incumbents. It will be appreciated that the ESC sensor deployment location 810 may be an ESC sensor deployment hut or other suitable location.

The ESC sensor deployment location 810 supports a set of corrective loops configured to enhance CBRS private enterprise cellular service availability and reliability within the DPA by supporting use of attenuation for preventing receiver saturation and enabling identification of channel(s) of the lower 100 MHz of the CBRS band being used by incumbent(s), thereby obviating the need to overprotect channels of the lower 100 MHZ of the shared spectrum band and, thus, ensuring availability of at least some channels of the lower 100 MHZ of the shared spectrum band for use for CBRS private enterprise cellular service in the DPA of the shared spectrum system.

The set of corrective loops includes an inner (or internal) corrective loop supported internally within the radar detection sensor 813. Namely, the radar detection sensor 813 includes an onboard internal attenuator on its receiver RF chain which is opportunistically employed to ensure that the received signal from a naval incumbent will not cause its receiver RF chain to saturate and render the radar detection sensor 813 incapable of identifying which portion of the lower 100 MHz of the CBRS shared spectrum the naval incumbent is currently occupying. However, when the inner corrective loop of the radar detection sensor 813 is unable to avoid the receiver saturation event (e.g., when the naval incumbent is a high-power incumbent), the radar detection sensor 813 eventually reports back to the ESC cloud entity 820 a status indicating that the radar detection sensor 813 is facing receiver saturation event due to the presence of a high-power new incumbent and, upon receiving such an indication, the ESC cloud entity 820 can only overprotect the incumbent and, thus, relays to SAS 830 to activate the DPA across the entire lower 100 MHZ of the shared spectrum in the affected DPA.

The set of corrective loops also includes an outer (or external) corrective loop that is based on the external attenuator 812, the radar detection sensor 813, and the computer 814. The outer corrective loop is configured to compensate for high-power incumbents for which the inner corrective loop is unable to successfully provide compensation, including compensating for high-power naval incumbents without requiring the ESC cloud entity 820 to overprotect the high-power naval incumbent. For example, the outer corrective loop, in the presence of a high-power incumbent, may be configured to overcome the receiver saturation event and identify the channel(s) of the lower 100 MHz of the CBRS shared spectrum occupied by the high-power incumbent (as well as any low-power incumbent(s) which also may be operating in the area), thereby enabling the ESC cloud entity 820 to support targeted protection of the occupied channels while ensuring that any remaining channels of the lower 100 MHz of the CBRS shared spectrum are available for use for CBRS private enterprise cellular service in the DPA of the shared spectrum system. The operation of the outer corrective loop based on the external attenuator 812 is discussed further below.

The computer 814 is configured to support operation of the ESC cloud entity 820 and the SAS 830 to provide protection for the DPA. When an incumbent arrives to the DPA, the computer 814 needs to be able to detect the presence of the incumbent and report the channel(s) of the lower 100 MHz of the CBRS band being used by the incumbent to the ESC cloud entity 820 so that the ESC cloud entity 820 can initiate activation of protection for the channel(s) of the lower 100 MHz of the CBRS band being used by the incumbent so that the channels of the lower 100 MHz of the CBRS band being used by the incumbent cannot be used by CBSDs 850. While identifying the channel(s) of the lower 100 MHz of the CBRS band being used by a low-power incumbent may be achieved based on the existing inner corrective loop of the radar detection sensor 813, the inner corrective loop of the radar detection sensor 813 probably will not be sufficient to support identification of the channel(s) of the lower 100 MHz of the CBRS band being used by a high-power incumbent.

When a low-power incumbent arrives to the DPA and the radar detection sensor 813 detects a receiver saturation event, an inner corrective loop of the radar detection sensor 813 attempts to use attenuation to alleviate the receiver saturation event and identify the channel(s) of the lower 100 MHz of the CBRS band being used by the low-power incumbent. The radar detection sensor 813 then provides an indication of the channel occupancy status to the computer 814 which forwards the channel occupancy status to the ESC cloud entity 820 to trigger activation of protection for the channel(s) of the lower 100 MHz of the CBRS band being used by the incumbent so that the channel(s) of the lower 100 MHz of the CBRS band being used by the incumbent cannot be used by the CBSDs 850. It is assumed, for purposes of clarity, the inner corrective loop will be sufficient to overcome the receiver saturation event from a lower-power incumbent. Here, in addition to reporting the channel occupancy status, the OAM module 815 of the computer 814 also may maintain the channel occupancy information of the low-power incumbent locally for use in supporting continued monitoring of the low-power incumbent in the presence of one or more high-power incumbents which may arrive to the DPA, as discussed further below.

When a high-power incumbent arrives to the DPA and the radar detection sensor 813 detects a receiver saturation event, the inner corrective loop of the radar detection sensor 813 attempts to use attenuation to alleviate the receiver saturation event and detect the channel(s) of the lower 100 MHz of the CBRS band being used by the high-power incumbent; however, due to the high power of the high-power incumbent, the inner corrective loop of the radar detection sensor 813 may be unable to compensate for the receiver saturation event and, thus, the channel(s) of the lower 100 MHz of the CBRS band being used by the high-power incumbent cannot be identified. So, the radar detection sensor 813 provides an indication of the receiver saturation event to the computer 814. The computer 814, however, rather than immediately reporting the receiver saturation event to the ESC cloud entity 820 (which would cause the ESC cloud entity 820 to trigger DPA protection activation over the entire lower 100 MHz of the CBRS band in order to ensure protection of the high-power incumbent due to lack of visibility to the channel(s) of the lower 100 MHz of the CBRS band being used by the high-power incumbent), prevents reporting of the receiver saturation event to the ESC cloud entity 820 and, instead, causes the OAM module 815 to activate the outer corrective loop, based on the external attenuator 812, to attempt to use additional attenuation to alleviate the receiver saturation event and identify the channel(s) of the lower 100 MHz of the CBRS band being used by the high-power incumbent.

The OAM module 815 activates the external attenuator 812 and modulates the attenuation level of the external attenuator 812 until identifying an attenuation level that is high enough to alleviate the receiver saturation event but low enough to permit identification of the channel(s) of the lower 100 MHz of the CBRS band being used by the high-power incumbent. The OAM module 815 may modulate the attenuation level of the external attenuator 812 until identifying a minimum attenuation level that both alleviates the receiver saturation event and permits identification of the channel(s) being used by the high power incumbent. The OAM module 815 may wait until this behavior is stabilized over a threshold length of time (e.g., 3 seconds, 5 seconds, or the like) before reporting the channel occupancy status to the ESC cloud entity 820. The OAM module 815, as discussed further below, may control modulation of the attenuation level of the external attenuator 812 in various ways until identifying the attenuation level that is high enough to alleviate the receiver saturation event but low enough to permit identification of the channel(s) of the lower 100 MHz of the CBRS band being used by the high-power incumbent.

The OAM module 815 may control modulation of the attenuation level of the external attenuator 812 as follows. The OAM module 815, upon determining that the radar detection sensor 813 is reporting a receiver saturation event, may activate the external attenuator 812 to start attenuation at the maximum possible attenuation value supported by the external attenuator 812 (e.g., 70 dBm, 60 dBm, or the like). The OAM module 815 may then modulate the attenuation level of the external attenuator 812 in one or more iterations, which may include one or more increases and/or decreases of the attenuation level using one or more attenuation level modulation amounts (e.g., fixed amounts that change from iteration to iteration, amounts that are set based on the amount(s) of the previous iteration(s), or the like, as well as various combinations thereof) based on one or more determinations (e.g., whether the receiver saturation event is overcome and/or whether the channel(s) of the lower 100 MHz of the CBRS band being used by the high-power incumbent are able to be identified), until the radar detection sensor 813 reports the channel(s) of the lower 100 MHz of the CBRS band being used by the high-power incumbent without getting into a receiver saturation event. The OAM module 815 may stop the attenuation modulation process once reaching an attenuation level that alleviates the receiver saturation event and permits identification of the channel(s) of the lower 100 MHz of the CBRS band being used by the high-power incumbent, or may continue the attenuation modulation process until reaching a minimum (or substantially minimum) attenuation level that alleviates the receiver saturation event and permits identification of the channel(s) of the lower 100 MHz of the CBRS band being used by the high-power incumbent. It will be appreciated that various algorithms may be used for controlling modulation of the attenuation level of the external attenuator 812 in a manner that enables the radar detection sensor 813 to report the channel(s) of the lower 100 MHz of the CBRS band being used by the high-power incumbent without getting into a receiver saturation event.

The OAM module 815, for example, may control modulation of the attenuation level of the external attenuator 812 as follows. The attenuation level may be set to a maximum attenuation level of 60 dBm (or approximately 60 dBm). If that attenuation level (e.g., 60 dBm) overcomes the receiver saturation event, then a second iteration is performed to reduce the attenuation level by half of the previous step size (e.g. decreased by 30 dBm to 30 dBm). If the new attenuation level of the second iteration (e.g., 30 dBm) does not overcome the receiver saturation event then the attenuation level is increased by half of the previous step size of the first iteration (e.g., increased by 15 dBm to 45 dBm), otherwise the attenuation level is decrease by half of the previous step size of the first iteration (e.g., decreased by 15 dBm to 15 dBm). If the attenuation level was increased in the second iteration (e.g., increased by 15 dBm to 45 dBm), then a determination is made as to whether the attenuation level of the second iteration overcomes the saturation event, and then a third iteration is performed to further increase the attenuation level (if the receiver saturation event is not overcome) or to decrease the attenuation level (if the receiver saturation event is overcome). If the attenuation level was decreased in the second iteration (e.g., decreased by 15 dBm to 15 dBm), then a determination is made as to whether the attenuation level of the second iteration overcomes the saturation event, and then a third iteration is performed to further decrease the attenuation level (if the receiver saturation event is overcome) or to increase the attenuation level (if the receiver saturation event is not overcome). It will be appreciated that, in at least some instances, multiple increases and/or multiple decreases may be performed in a row in order to reach an attenuation level that overcomes the receiver saturation event and/or permits channel identification. In this manner, various iterations of attenuation level modulation may be used to arrive at an attenuation level (possibly a minimum attenuation level) that alleviates the receiver saturation event and permits identification of the channel(s) of the lower 100 MHz of the CBRS band being used by the high-power incumbent.

The OAM module 815, for example, may control modulation of the attenuation level of the external attenuator 812 as follows. The attenuation level may be set to a maximum attenuation level of 60 dBm. If that attenuation level (e.g., 60 dBm) overcomes the receiver saturation event, then a second iteration is performed to reduce the attenuation level by one third of the previous step size (e.g. decreased by 20 dBm to 40 dBm). If the new attenuation level of the second iteration (e.g., 40 dBm) does not overcome the receiver saturation event then the attenuation level is increased by half of the previous step size of the first iteration (e.g., increased by 10 dBm to 50 dBm), otherwise the attenuation level is decrease by half of the previous step size of the first iteration (e.g., decreased by 10 dBm to 30 dBm). If the attenuation level was increased in the second iteration (e.g., increased by 10 dBm to 50 dBm), then a determination is made as to whether the attenuation level of the second iteration overcomes the saturation event, and then a third iteration is performed to further increase the attenuation level (if the receiver saturation event is not overcome) or to decrease the attenuation level (if the receiver saturation event is overcome). If the attenuation level was decreased in the second iteration (e.g., decreased by 10 dBm to 30 dBm), then a determination is made as to whether the attenuation level of the second iteration overcomes the saturation event, and then a third iteration is performed to further decrease the attenuation level (if the receiver saturation event is overcome) or to increase the attenuation level (if the receiver saturation event is not overcome). It will be appreciated that, in at least some instances, multiple increases and/or multiple decreases may be performed in a row in order to reach an attenuation level that overcomes the receiver saturation event and/or permits channel identification. In this manner, various iterations of attenuation level modulation may be used to arrive at an attenuation level (possibly a minimum attenuation level) that alleviates the receiver saturation event and permits identification of the channel(s) of the lower 100 MHz of the CBRS band being used by the high-power incumbent.

The OAM module 815, as may be seen at least from the examples above, may control modulation of the attenuation level of the external attenuator 812 in various ways such that the outer corrective loop may be used to overcome the receiver saturation event and permit identification of the channel(s) of the lower 100 MHz of the CBRS band being used by the high-power incumbent. For example, in the attenuation modulation process, it will be understood, more generally, that each time the attenuation level is decreased a determination needs to be made to ensure that the lower attenuation level is still sufficient to overcome the receiver saturation event and each time the attenuation level is increased a determination needs to be made to ensure that the higher attenuation level is not too high such that the channels(s) of the high-power incumbent cannot be identified. It will be appreciated that, in at least some instances, multiple increases and/or multiple decreases may be performed in a row in order to reach an attenuation level that overcomes the receiver saturation event and/or permits channel identification. It will be appreciated that other arrangements of iterations may be supported (e.g., other numbers of iterations may be supported, different bases for determination of attenuation level modification step sizes may be supported, or the like, as well as various combinations thereof). In this manner, the attenuation modulation algorithm enables the outer corrective loop to approach an attenuation level that alleviates the receiver saturation event and permits identification of the channel(s) of the lower 100 MHz of the CBRS band being used by the high-power incumbent.

The OAM module 815, after attempting to use the outer corrective loop to alleviate the receiver saturation event and identify the channel(s) of the lower 100 MHz of the CBRS band being used by the high-power incumbent, sends a notification to the ESC cloud entity 820 to trigger DPA activation to protect the channel(s) of the lower 100 MHz of the CBRS band being used by the high-power incumbent. The OAM module 815, after successfully using the outer corrective loop to alleviate the receiver saturation event and identify the channel(s) of the lower 100 MHz of the CBRS band being used by the high-power incumbent, and ensuring that the behavior is stabilized over a threshold length of time, provides an indication of the channel occupancy status to the ESC cloud entity 820 to cause the SAS 830 to trigger activation of DPA protection for the channel(s) of the high-power incumbent so that those channels cannot be used by CBSDs 850, thereby enabling other channel(s) of the lower 100 MHz of the CBRS band to remain available for use by the CBSDs 850. The OAM module 815, if unable, after a threshold length of time, to use the outer corrective loop to alleviate the receiver saturation event and identify the channel(s) being used by the high-power incumbent (e.g., either the receiver saturation event is not alleviated or the receiver saturation event is alleviated but the attenuation level is too high to permit identification of the channel(s) being used by the high-power incumbent), provides an indication of the receiver saturation event to the ESC cloud entity 820 to cause the SAS 830 to trigger activation of DPA protection over the entire lower 100 MHz of the CBRS band (the ESC overprotects the entire lower 100 MHz of the CBRS band to ensure protection of whichever channel(s) are being used by the high-power incumbent).

The OAM module 815, after using the outer corrective loop to attempt to alleviate the receiver saturation event and identify the channel(s) being used by the high-power incumbent, may periodically control the outer corrective loop to reassess the situation within the DPA. As discussed further below, the manner in which the outer corrective loop is controlled to reassess the situation in the DPA may depend on whether the outer corrective loop was previously unable to alleviate the receiver saturation event and identify the channel(s) being used by the high-power incumbent or whether the outer corrective loop was previously able to alleviate the receiver saturation event and identify the channel(s) being used by the high-power incumbent, both of which are discussed further below. For example, the control over the outer corrective loop may include activating or deactivating the outer corrective loop (e.g., activating the external attenuator 812 from no external attenuation to maximum external attenuation or deactivating the external attenuator 812 from providing external attenuation to not providing external attenuation), incrementally increasing or decreasing the attenuation level of the external attenuator 812, or the like, as well as various combinations thereof. It will be appreciated that the outer corrective loop may be controlled in other ways to reassess the situation within the DPA.

The OAM module 815, where the outer corrective loop was previously unable to alleviate the receiver saturation event and identify the channel(s) being used by the high-power incumbent (and, thus, overprotection of the incumbent in the DPA was activated by triggering activation of DPA protection over the entire lower 100 MHz of the CBRS band), may periodically attempt to use to the outer corrective loop to alleviate the receiver saturation event and identify the channel(s) being used by the high-power incumbent (for enabling the CBSDs to use the remaining available PAL channels of the entire lower 100 MHz of the CBRS band). In this case, the OAM module 815 may attempt to use to the outer corrective loop to alleviate the receiver saturation event and identify the channel(s) being used by the high-power incumbent in a manner similar to use of the outer corrective loop when the high-power incumbent was first detected in the DPA (e.g., the OAM module 815 may periodically activate the outer corrective loop to determine whether the outer corrective loop may be successfully used to alleviate the receiver saturation event and identify the channel(s) being used by the high-power incumbent).

The OAM module 815, where the outer corrective loop was previously able to alleviate the receiver saturation event and identify the channel(s) being used by the high-power incumbent (and, thus, avoid overprotection of the incumbent in the DPA and permit the CBSDs to use the remaining available PAL channels of the entire lower 100 MHz of the CBRS band), may periodically control the outer corrective loop to determine whether the high-power incumbent is still present within the DPA and to determine whether presence of low-power incumbents in the DPA has changed since the last time that the outer corrective loop was activated. In this case, the OAM module 815 may control the outer corrective loop, to determine whether the high-power incumbent is still present within the DPA and to determine whether presence of low-power incumbents in the DPA has changed since the last time that the outer corrective loop was activated, by periodically deactivating the outer corrective loop, periodically running an iterative process to attempt to remove external attenuation provided by the outer corrective loop, or the like, as well as various combinations thereof. It will be appreciated that the outer corrective loop may be controlled by the OAM module 815 in other ways to determine whether use of the external attenuation can be reduced or even eliminated without the radar detection sensor 813 again experiencing a receiver saturation event.

The OAM module 815, as indicated above, may periodically reassess the situation in the DPA by deactivating the outer corrective loop based on deactivation of the external attenuator 812 to determine which incumbent(s) are still present within the DPA. The OAM module 815, after deactivating the outer corrective loop, waits to see whether the radar detection sensor 813 again detects a receiver saturation event that requires reactivation of the outer corrective loop. If the receiver saturation event is no longer detected then the high-power incumbent is likely no longer present in the DPA and, in this case, the ESC sensor deployment location 810 can continue to operate as usual to detect and report any low-power incumbent(s) that might be located in the DPA (e.g., low-power incumbents that were previously present and/or that may have arrived since the last periodic deactivation of the outer corrective loop). If the receiver saturation event is still detected then the high-power incumbent is likely still present in the DPA (or a new high-power incumbent is present even if the previous high-power incumbent left) and, in this case, the ESC sensor deployment location 810 can reactivate the outer corrective loop to alleviate the receiver saturation event and identify the channel(s) of the lower 100 MHz of the CBRS band being used by the high-power incumbent, as well as any channel(s) being used by low-power incumbents. Here, the reactivation of the outer corrective loop may be performed by reactivating the outer corrective loop to the most recently used attenuation level for the external attenuator 812 or to the maximum possible attenuation level of the external attenuator 812 and, if necessary, modulating the attenuation level of the external attenuator 812 until finding a new attenuation level of the external attenuator 812 that alleviates the receiver saturation event and enables identification of the channel(s) of the lower 100 MHz of the CBRS band being used by the high-power incumbent.

The OAM module 815, as indicated above, may periodically reassess the situation in the DPA by iteratively decreasing the attenuation level of the external attenuator 812 to determine which incumbent(s), if any, are still present within the DPA. The lowering of the external attenuation in iterations may be performed using any suitable iteration durations (e.g., each iteration is 2 seconds, each iteration is 4 seconds, or the like) and the lowering of the external attenuation may be performed in any suitable step sizes (e.g., using step sizes that may be constant within the iterations (e.g., 5 dBm per iteration, 8 dBm per iteration, or the like) or which may vary across the iterations). The OAM module 815, after decreasing the attenuation level of the external attenuator 812 in a current iteration, waits to see whether the radar detection sensor 813 again detects a receiver saturation event. If the OAM module 815 determines that the radar detection sensor 813 does again detect a receiver saturation event after the decrease of the external attenuation level, the OAM module 815 will increase the attenuation level of the external attenuator 812 (e.g., to the most recently used attenuation level for the external attenuator 812 from the previous iteration of the reassessment, to the previous attenuation level of the external attenuator used prior to initiation of the reassessment, or to the maximum possible attenuation level of the external attenuator 812) and, if necessary, modulate the attenuation level of the external attenuator 812 until finding a new attenuation level of the external attenuator 812 that alleviates the receiver saturation event and enables identification of the channel(s) of the lower 100 MHz of the CBRS band being used by all naval incumbents including the high-power incumbent and any low-power incumbents which may be present. If the OAM module 815 determines that the radar detection sensor 813 does not detect a receiver saturation event after the decrease of the external attenuation level, the OAM module 815 proceeds to a next iteration and again lowers the external attenuation level of the external attenuator 812. The OAM module 815 may continue in this manner until identifying a new optimum level of the attenuation level that alleviates the receiver saturation event and enables identification of the channel(s) of the lower 100 MHz of the CBRS band being used by the high-power incumbent or until the external attenuation is completely deactivated if there is no longer any high-power incumbent in the DPA.

The OAM module 815, although primarily presented as being configured to identify and protect a high-power incumbent present within the DPA, may be configured to identify and protect all incumbents in the DPA while at least one high-power incumbent is present within the DPA. As indicated above, sometimes there are multiple naval incumbents present within the same DPA. but occupying different orthogonal channels. For example, where two incumbents are present, one of the incumbents may be a high-power incumbent causing a receiver saturation event, while the other incumbent may be a lower-power incumbent that does not result in receiver saturation (e.g., the low-power naval incumbent may be occupying channel 3 in the lower 100 MHZ of the CBRS band, while the high-power naval incumbent may be occupying channels 7 and 8 in the lower 100 MHZ of the CBRS band). The OAM module 815, in order to ensure that all incumbents in the DPA can be detected, identified, and reported, may be configured to control the outer corrective loop in a manner for ensuring that the receiver saturation event caused by any high-power incumbent(s) is alleviated and for enabling identification of the channel(s) of the lower 100 MHz of the CBRS band being used by the high-power incumbent(s) and the low-power incumbent(s), thereby enabling targeted control over activation of protection on specific channels of the lower 100 MHz of the CBRS band rather than requiring overprotection by activating protection on the entire lower 100 MHz of the CBRS band.

The OAM module 815, while a high-power incumbent is present within the DPA, may be configured to identify and protect all incumbents in the DPA by maintaining a list of all incumbents present within the DPA as reported by the radar detection sensor 813 and, in response to detection of a receiver saturation event as reported by the radar detection sensor 813 for the high-power incumbent, activate the external attenuator 812 and modulate the attenuation level of the external attenuator 812 until identifying an attenuation level that both alleviates the receiver saturation event and permits identification of the channel(s) being used by all of the incumbents including the high-power incumbent as well as any low-power incumbent known by the OAM module 815 to be present within the DPA. Here, the modulation of the attenuation level of the external attenuator 812 may be controlled in a manner for activating an attenuation level which, in addition to alleviating the receiver saturation event, not only permits identification of the channel(s) being used by the high-power incumbent which caused the receiver saturation event for the DPA but which also permits identification of the channel(s) being used by any other incumbent(s) which are present within the DPA. This enables targeted control over activation of protection on specific channels of the lower 100 MHz of the CBRS band rather than requiring overprotection by activating protection on the entire lower 100 MHZ of the CBRS band (e.g., in the example above, only activating protection on channels 3, 7, and 8 in the lower 100 MHZ of the CBRS band, thereby enabling channels 1-2, 4-6, and 9-10 in the lower 100 MHZ of the CBRS band to remain available for use by private enterprise customers).

It will be appreciated that the ESC sensor deployment location 810 is configured such that the ESC sensor will have the ability to get out of the receiver saturation event within a few seconds and protect the dynamic high-power incumbents without taking out the entire lower 100 MHz of the CBRS band for a non-deterministic time that could last hours, days, weeks, or even longer, thereby enhancing the reliability and availability of the mission critical private enterprise cellular network operations using shared spectrum in coastal areas or in any areas where high-power incumbents may operate.

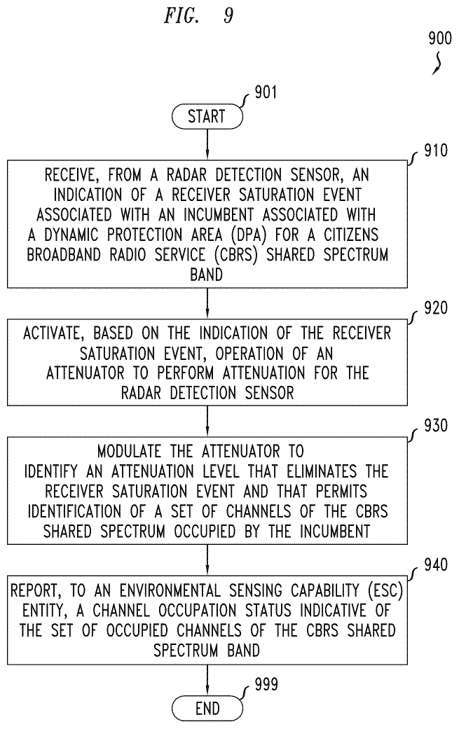

FIG. 9 is a flow diagram of a method for providing enhanced availability and reliability of CBRS private enterprise cellular service in a shared spectrum system according to some embodiments. It will be appreciated that, although primarily presented herein as being performed serially, at least a portion of the functions of method 900 may be performed contemporaneously or in a different order than as presented in FIG. 9. At block 901, the method 900 begins. At block 910, receive, from a radar detection sensor, an indication of a receiver saturation event associated with an incumbent associated with a dynamic protection area (DPA) for a Citizens Broadband Radio Service (CBRS) shared spectrum band. At block 920, activate, based on the indication of the receiver saturation event, operation of an attenuator to perform attenuation for the radar detection sensor. At block 930, modulate the attenuator to identify an attenuation level that eliminates the receiver saturation event and that permits identification of a set of channels of the CBRS shared spectrum occupied by the incumbent. At block 940, report, to an environmental sensing capability (ESC) entity, a channel occupation status indicative of the set of occupied channels of the CBRS shared spectrum band. At block 999, the method 900 ends.

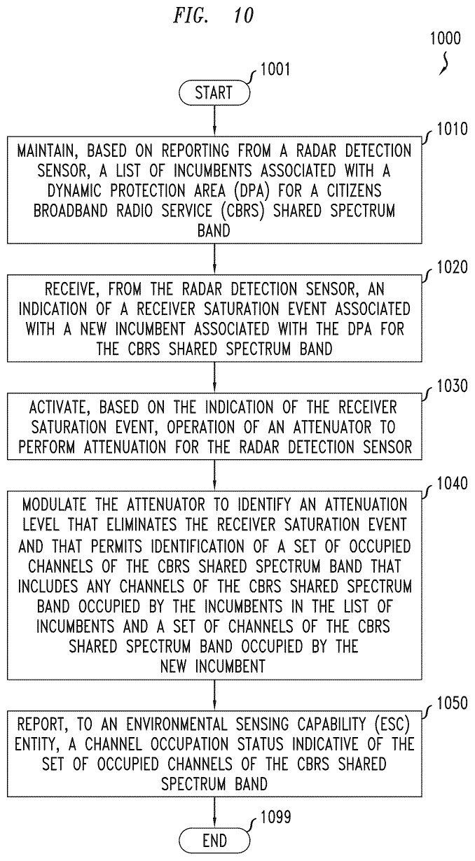

FIG. 10 is a flow diagram of a method for providing enhanced availability and reliability of CBRS private enterprise cellular service in a shared spectrum system according to some embodiments. It will be appreciated that, although primarily presented herein as being performed serially, at least a portion of the functions of method 1000 may be performed contemporaneously or in a different order than as presented in FIG. 10. At block 1001, the method 1000 begins. At block 1010, maintain, based on reporting from a radar detection sensor, a list of incumbents associated with a dynamic protection area (DPA) for a Citizens Broadband Radio Service (CBRS) shared spectrum band. At block 1020, receive, from the radar detection sensor, an indication of a receiver saturation event associated with a new incumbent associated with the DPA for the CBRS shared spectrum band. At block 1030, activate, based on the indication of the receiver saturation event, operation of an attenuator to perform attenuation for the radar detection sensor. At block 1040, modulate the attenuator to identify an attenuation level that eliminates the receiver saturation event and that permits identification of a set of occupied channels of the CBRS shared spectrum band that includes any channels of the CBRS shared spectrum band occupied by the incumbents in the list of incumbents and a set of channels of the CBRS shared spectrum band occupied by the new incumbent. At block 1050 report, to an environmental sensing capability (ESC) entity, a channel occupation status indicative of the set of occupied channels of the CBRS shared spectrum band. At block 1099, the method 1000 ends.

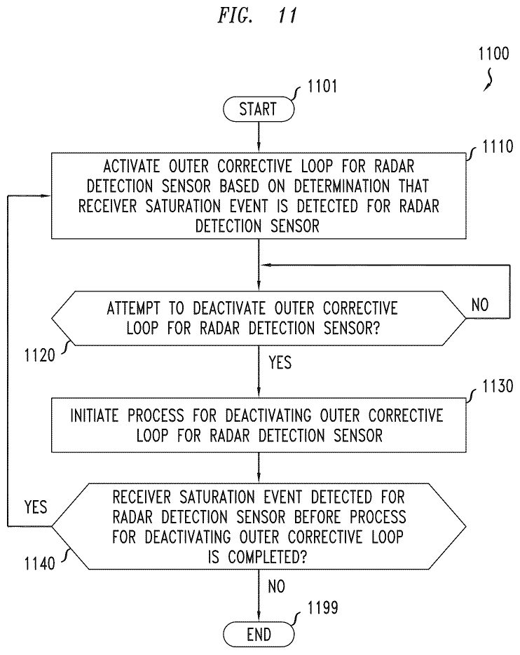

FIG. 11 is a flow diagram of a method for providing enhanced availability and reliability of CBRS private enterprise cellular service in a shared spectrum system according to some embodiments. It will be appreciated that, although primarily presented herein as being performed serially, at least a portion of the functions of method 1100 may be performed contemporaneously or in a different order than as presented in FIG. 11.

At block 1101, the method 1100 begins.

At block 1110, activate an outer corrective loop for a radar detection sensor based on a determination that a receiver saturation event is detected for the radar detection sensor. The outer corrective loop is activated for the radar detection sensor, using an external attenuator associated with the radar detection sensor and based on a determination that an internal corrective loop of the radar detection sensor based on an internal attenuator of the radar detection sensor is unable to alleviate a receiver saturation event and identify channels being used by incumbents, to alleviate the receiver saturation event and identify channels being used by the incumbents to provide targeted protection of the incumbents. It will be appreciated that the activation of the corrective loop for a radar detection sensor, to alleviate the receiver saturation event and identify channels being used by the incumbents, may be performed based on the method 900 of FIG. 9 or the method 1000 of FIG. 10.

At block 1120, determine whether to attempt to deactivate the outer corrective loop for the radar detection sensor. This determination as to whether to attempt to deactivate the outer corrective loop for the radar detection sensor may be performed by monitoring a timer or other mechanism for periodically determining whether the outer loop for the radar detection sensor can be deactivated, monitoring for one or more events which may trigger an attempt to deactivate the outer corrective loop, or the like, as well as various combinations thereof. If a determination is made not to attempt to deactivate the outer corrective loop for the radar detection sensor then the method 1100 remains at block 1120 to continue to determine whether to attempt to deactivate the outer corrective loop for the radar detection sensor. If a determination is made to attempt to deactivate the outer corrective loop for the radar detection sensor then the method 1100 proceeds to block 1130.

At block 1130, initiate a process for deactivating the outer corrective loop for the radar detection sensor. The process for deactivating the outer corrective loop could include deactivating the outer corrective loop to determine whether the receiver saturation event from the high-power incumbent is still detected or iteratively decreasing the attenuation level of the external attenuator of the outer corrective loop to determine whether the receiver saturation event from the high-power incumbent is still detected.

At block 1140, determine whether a receiver saturation event is detected for the radar detection sensor before the process for deactivating the outer corrective loop is completed. If the process for deactivating the outer corrective loop is not completed without detection of the receiver saturation event (e.g., the receiver saturation event is again detected when the attenuation provided by the external attenuator is either removed or decreased as part of the process for deactivating the outer corrective loop), then the method 1100 returns to block 1110 to reactivate the outer corrective loop to again alleviate the receiver saturation event and identify channels being used by the incumbents to provide targeted protection of the incumbents. If the process for deactivating the outer corrective loop is completed without detection of the receiver saturation event, then the outer corrective loop is no longer needed (e.g., the high-power incumbent that previously caused activation of the outer corrective loop is no longer present), then the method 1100 proceeds to block 1199, where the method 1100 ends.

At block 1199, the method 1100 ends.

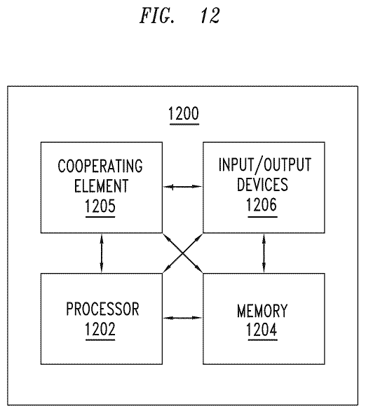

FIG. 12 depicts an example embodiment of a computer suitable for use in performing various functions presented herein.

The computer 1200 includes a processor 1202 (e.g., a central processing unit (CPU), a graphics processing unit (GPU), a processor, a processor core of a processor, a subset of processor cores of a processor, a set of processor cores of a processor, or the like) and a memory 1204 (e.g., a random access memory (RAM), a read-only memory (ROM), or the like). In at least some example embodiments, the computer 1200 may include at least one processor and at least one memory storing instructions that, when executed by the at least one processor, cause the computer to perform various functions presented herein.

The computer 1200 also may include a cooperating element 1205. The cooperating element 1205 may be a hardware device. The cooperating element 1205 may be a process that can be loaded into the memory 1204 and executed by the processor 1202 to implement various functions presented herein (in which case, for example, the cooperating element 1205 (including associated data structures) can be stored on a non-transitory computer readable medium, such as a storage device or other suitable type of storage element (e.g., a magnetic drive, an optical drive, or the like)).

The computer 1200 also may include one or more input/output devices 1206. The input/output devices 1206 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 1200 may represent a general architecture and functionality suitable for implementing functional elements described herein, portions of functional elements described herein, or the like, as well as various combinations thereof. For example, computer 1200 may provide a general architecture and functionality that is suitable for implementing one or more elements presented herein, such as a CBSD or a portion thereof, an SAS or a portion thereof, an ESC entity or a portion thereof, a radar detection sensor or a portion thereof, a control computer or a portion thereof, a management module or a portion thereof, or the like, as well various combinations thereof.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits, and/or any other hardware equivalents).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer readable media), transmitted via a data stream in a broadcast or other signal bearing medium, and/or stored within a memory within a computing device operating according to the instructions.

It will be appreciated that the term “non-transitory” as used herein is a limitation of the medium itself (i.e., tangible, not a signal) as opposed to a limitation of data storage persistency (e.g., RAM versus ROM).

It will be appreciated that, as used herein, “at least one of <a list of two or more elements>” and “at least one of the following: <a list of two or more elements>” and similar wording, where the list of two or more elements are joined by “and” or “or”, mean at least any one of the elements, or at least any two or more of the elements, or at least all the elements.

It will be appreciated that, as used herein, the term “or” refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1-20. (canceled)

21. An apparatus, comprising:
at least one processor; and
at least one memory storing instructions which, when executed by at least one processor, cause the apparatus at least to:
maintain, based on reporting from a radar detection sensor, a list of incumbents associated with a dynamic protection area (DPA) for a Citizens Broadband Radio Service (CBRS) shared spectrum band;
receive, from the radar detection sensor, an indication of a receiver saturation event associated with a new incumbent associated with the DPA for the CBRS shared spectrum band;
activate, based on the indication of the receiver saturation event, operation of an attenuator to perform attenuation for the radar detection sensor;
modulate the attenuator to identify an attenuation level that eliminates the receiver saturation event and that permits identification of a set of occupied channels of the CBRS shared spectrum band that includes any channels of the CBRS shared spectrum band occupied by the incumbents in the list of incumbents and a set of channels of the CBRS shared spectrum band occupied by the new incumbent; and
report, to an environmental sensing capability (ESC) entity, a channel occupation status indicative of the set of occupied channels of the CBRS shared spectrum band.

22. The apparatus of claim 21, wherein the list of incumbents includes at least one low-power incumbent and the new incumbent includes a high-power incumbent.

23. The apparatus of claim 22, wherein the list of incumbents includes at least one additional high-power incumbent.

24. The apparatus of claim 21, wherein the indication of the receiver saturation event associated with the new incumbent associated with the DPA for the CBRS shared spectrum band is received based on a failure of an attenuator of the radar detection sensor to eliminate the receiver saturation event for the radar detection sensor.

25. The apparatus of claim 21, wherein the instructions, when executed by the at least one processor, cause the apparatus at least to:
prevent reporting of the receiver saturation event to the ESC entity for preventing activation of protection by the ESC entity for the entire CBRS shared spectrum band as opposed to only the set of occupied channels of the CBRS shared spectrum band.

26. The apparatus of claim 21, wherein the attenuation level of the attenuator at activation is a maximum possible attenuation level of the attenuator.

27. The apparatus of claim 21, wherein, to modulate the attenuator, the instructions, when executed by the at least one processor, cause the apparatus at least to:
decrease the attenuation level of the attenuator based on a determination that the radar detection sensor is not taken out of the receiver saturation event by a previous attenuation modulation operation performed for the attenuator.

28. The apparatus of claim 27, wherein the attenuation level is decreased by half of a previous value of the attenuation level resulting from the previous attenuation modulation operation performed for the attenuator.

29. The apparatus of claim 21, wherein, to modulate the attenuator, the instructions, when executed by the at least one processor, cause the apparatus at least to:
increase the attenuation level of the attenuator based on a determination that the radar detection sensor is taken out of the receiver saturation event by a previous attenuation modulation operation performed for the attenuator.

30. The apparatus of claim 29, wherein the attenuation level is increased by half of a previous value of the attenuation level resulting from the previous attenuation modulation operation performed for the attenuator.

31. The apparatus of claim 21, wherein, to modulate the attenuator, the instructions, when executed by the at least one processor, cause the apparatus at least to:
decrease the attenuation level of the attenuator based on a determination that the radar detection sensor is taken out of the receiver saturation event by a previous attenuation modulation operation performed for the attenuator and a determination that the set of occupied channels of the CBRS shared spectrum band is successfully identified.

32. The apparatus of claim 31, wherein the attenuation level is decreased by half of a previous value of the attenuation level resulting from the previous attenuation modulation operation performed for the attenuator.

33. The apparatus of claim 21, wherein the instructions, when executed by the at least one processor, cause the apparatus at least to:
periodically perform a process for iteratively decreasing the attenuation level of the attenuator until detecting a new receiver saturation event or until the attenuation level of the attenuator reaches zero.

34. The apparatus of claim 33, wherein the instructions, when executed by the at least one processor, cause the apparatus at least to:
modulate, based on a determination that the new receiver saturation event is detected, the attenuator to identify a new attenuation level that eliminates the receiver saturation event and that permits identification of the set of occupied channels of the CBRS shared spectrum band.

35. The apparatus of claim 21, wherein the instructions, when executed by the at least one processor, cause the apparatus at least to:
deactivate the attenuator to determine whether the receiver saturation event is still present; and
update the list of incumbents associated with the DPA for the CBRS shared spectrum band, while the attenuator is deactivated, to obtain an updated list of incumbents associated with the DPA for the CBRS shared spectrum band.

36. The apparatus of claim 35, wherein the instructions, when executed by the at least one processor, cause the apparatus at least to:
reactivate the attenuator based on detection of a new receiver saturation event while the attenuator is deactivated; and
modulate, based on the new receiver saturation event and the updated list of incumbents associated with the DPA for the CBRS shared spectrum band, the attenuator to identify a new attenuation level that eliminates the receiver saturation event and that permits identification of the set of occupied channels of the CBRS shared spectrum band.

37. The apparatus of claim 21, wherein the attenuation level comprises a minimum attenuation level that eliminates the receiver saturation event and that permits identification of the set of occupied channels of the CBRS shared spectrum band.

38. The apparatus of claim 21, wherein the CBRS shared spectrum band comprises a lower 100 MHz of the CBRS band.

39. A computer-readable storage medium storing computer program instructions which, when executed by an apparatus, cause the apparatus at least to:
maintain, based on reporting from a radar detection sensor, a list of incumbents associated with a dynamic protection area (DPA) for a Citizens Broadband Radio Service (CBRS) shared spectrum band;
receive, from the radar detection sensor, an indication of a receiver saturation event associated with a new incumbent associated with the DPA for the CBRS shared spectrum band;
activate, based on the indication of the receiver saturation event, operation of an attenuator to perform attenuation for the radar detection sensor;
modulate the attenuator to identify an attenuation level that eliminates the receiver saturation event and that permits identification of a set of occupied channels of the CBRS shared spectrum band that includes any channels of the CBRS shared spectrum band occupied by the incumbents in the list of incumbents and a set of channels of the CBRS shared spectrum band occupied by the new incumbent; and
report, to an environmental sensing capability (ESC) entity, a channel occupation status indicative of the set of occupied channels of the CBRS shared spectrum band.

40. A method, comprising:
maintaining, based on reporting from a radar detection sensor, a list of incumbents associated with a dynamic protection area (DPA) for a Citizens Broadband Radio Service (CBRS) shared spectrum band;
receiving, from the radar detection sensor, an indication of a receiver saturation event associated with a new incumbent associated with the DPA for the CBRS shared spectrum band;
activating, based on the indication of the receiver saturation event, operation of an attenuator to perform attenuation for the radar detection sensor;
modulating the attenuator to identify an attenuation level that eliminates the receiver saturation event and that permits identification of a set of occupied channels of the CBRS shared spectrum band that includes any channels of the CBRS shared spectrum band occupied by the incumbents in the list of incumbents and a set of channels of the CBRS shared spectrum band occupied by the new incumbent; and
reporting, to an environmental sensing capability (ESC) entity, a channel occupation status indicative of the set of occupied channels of the CBRS shared spectrum band.
